(19) United States
(12) Patent Application Publication
(10) Pub. No.: US 2026/0109477 A1
(43) Pub. Date: Apr. 23, 2026

(54) Multi-Vehicle Omnidirectional Aircraft Maneuvering

(71) Applicant: TowFLEXX MilTech, Inc., New Castle, DE (US)

(72) Inventors: Axel Schickling, Visbek (DE); Tobias Strobl, Las Vegas, NV (US); Christian Frilling, Visbek (DE)

(73) Assignee: TowFLEXX MilTech, Inc., New Castle, DE (US)

(21) Appl. No.: 19/250,592

(22) Filed: Jun. 26, 2025

Related U.S. Application Data
(63) Continuation-in-part of application No. 19/072,829, filed on Mar. 6, 2025, now Pat. No. 12,545,434.
Application No. 19/072,829 is a continuation of application No. 18/920,075, filed on Oct. 18, 2024, now Pat. No. 12,269,612.

(51) Int. Cl. B64F 1/228; B64F 1/02; B64F 1/24; G05D 1/437

(52) U.S. Cl. CPC B64F 1/228; B64F 1/02; B64F 1/24; G05D 1/437

(57) ABSTRACT

The present disclosure provides a multi-vehicle omnidirectional aircraft maneuvering system comprising a plurality of tow vehicles, each tow vehicle comprising a turntable lifting unit (TLU) configured to capture and secure a portion of an aircraft's landing gear, a control unit configured to communicate with and coordinate the movements of the plurality of tow vehicles, and wherein each TLU comprises an automated turntable, a gate configured to open and close to receive landing gear, and a moving floor configured to support the landing gear. The system enables precise positioning and omnidirectional movement of aircraft through coordinated operation of multiple tow vehicles that simultaneously engage with different landing gear components. Each tow vehicle includes sensors for detecting landing gear position and environmental conditions, while the control unit establishes wireless communication to synchronize lifting operations and coordinate simultaneous movement patterns. The turntable lifting units provide rotational capability while maintaining secure engagement with the aircraft's landing gear, allowing for complex maneuvering operations in confined spaces such as aircraft hangars and maintenance facilities.

### CROSS-REFERENCE TO RELATED APPLICATIONS

This application is a continuation-in-part of U.S. application Ser. No. 19/072,829, filed Mar. 6, 2025, which is a continuation of U.S. application Ser. No. 18/920,075, filed Oct. 18, 2024 all of which are hereby incorporated by reference in their entireties.

### FIELD OF INVENTION

The present disclosure relates to aircraft ground handling systems, and more particularly to a multi-vehicle omnidirectional aircraft maneuvering system comprising multiple tow vehicles with turntable lifting units that work in coordination to capture, lift, and precisely position aircraft in confined spaces.

### BACKGROUND

Aircraft ground handling operations, including towing, pushback, and repositioning, are critical tasks performed at airports and on aircraft carriers. These operations require precise control and maneuvering of aircraft in confined spaces to ensure safety and efficiency. Conventional towing methods often involve the use of towbars, which can be cumbersome to connect and disconnect, and may place stress on the aircraft's landing gear during turns.

Towing vehicles for aircraft have evolved to include towbarless designs that directly engage the nose landing gear. These vehicles typically have a rotating platform or turntable to allow the aircraft to be turned while towing. However, existing systems may still face challenges in maintaining proper alignment between the tow vehicle and the aircraft, particularly during tight maneuvers or in adverse weather conditions.

The increasing size and complexity of modern aircraft, combined with the need for more efficient ground operations, has created a demand for more advanced and autonomous towing solutions. There is a particular need for systems that can reduce the risk of damage to aircraft, improve operational efficiency, and minimize the personnel required for ground handling tasks.

Additionally, as airports and aircraft carriers become more congested, there is a growing need for tow vehicles that can operate in tighter spaces and perform more precise maneuvers. This includes the ability to reposition aircraft quickly and safely in hangars, on flight decks, and in other confined areas where traditional towing methods may be impractical or inefficient.

In some cases, multi-vehicle towing systems have been proposed to address these challenges. These systems may utilize multiple tow vehicles working in coordination to move a single aircraft. However, existing multi-vehicle systems may face difficulties in maintaining synchronization between vehicles, potentially leading to misalignment or uneven force distribution that could damage the aircraft or compromise safety.

Additionally, the increasing demand for operational flexibility at airports and on aircraft carriers has highlighted the need for towing systems that can move aircraft in any direction without the need for complex repositioning maneuvers. Omnidirectional movement capabilities may allow for more efficient use of limited space and reduce the time required for aircraft repositioning.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

A multi-vehicle omnidirectional aircraft maneuvering system is disclosed that comprises multiple tow vehicles working in coordination to provide precise aircraft positioning and movement capabilities. Each tow vehicle may include a turntable lifting unit (TLU) configured to capture and secure a portion of an aircraft's landing gear, enabling distributed weight support and enhanced maneuverability.

The system may include a control unit configured to establish wireless communication with each tow vehicle and coordinate their simultaneous movements. The control unit may synchronize the operations of all turntable lifting units and manage the coordinated lifting, positioning, and movement of aircraft in omnidirectional patterns. The control unit may communicate with each of the plurality of tow vehicles to coordinate simultaneous movement of the plurality of tow vehicles to maneuver the aircraft omnidirectionally.

Each turntable lifting unit may comprise an automated turntable providing rotational capability, a gate configured to open and close for receiving landing gear, and a moving floor configured to support and lift the landing gear. The tow vehicles may be equipped with sensor systems configured to detect the position and orientation of aircraft landing gear, location information of the tow vehicle, and environmental conditions. The sensor systems may provide real-time data to the control unit, which processes this information for spatial awareness within an airport environment and coordinates movements with airport traffic management systems.

In some aspects, the system may utilize at least three tow vehicles, with each tow vehicle assigned to engage with a respective landing gear component of the aircraft. Each tow vehicle may be capable of rotating 360 degrees while maintaining secure engagement with its designated landing gear, allowing for complex maneuvering operations without placing undue stress on the aircraft structure. This configuration enables the system to perform omnidirectional movements with the aircraft, including sideways motion, rotation in place, and precise positioning in confined spaces.

The control unit may be configured to monitor lifting forces applied by each tow vehicle to maintain balanced weight distribution across multiple contact points and adjust operations in real-time to prevent structural stress during aircraft handling. The system may execute predefined maneuvering patterns autonomously based on real-time sensor data from the multiple tow vehicles. The control unit may coordinate simultaneous lifting of the aircraft by synchronizing the TLUs of the plurality of tow vehicles, ensuring balanced and stable lifting operations.

In some implementations, the system may include a support platform configured to interface with the plurality of tow vehicles, where the support platform may be positioned beneath the aircraft to provide distributed weight support across multiple contact points. The support platform may incorporate rigid structural elements with flexible support components to accommodate various aircraft configurations. This platform-based approach may be particularly useful for aircraft with damaged landing gear or for specialized maintenance operations requiring uniform support of the aircraft's underbody.

The disclosed system may enable omnidirectional aircraft movement in confined spaces such as aircraft hangars, maintenance facilities, and manufacturing environments, potentially improving operational efficiency and reducing the time required for aircraft repositioning operations.

A method for omnidirectional aircraft maneuvering using multiple vehicles is also disclosed, comprising: providing a plurality of tow vehicles, each with a TLU; establishing wireless communication with each tow vehicle using a control unit; detecting the position and orientation of the aircraft's landing gear and surrounding environment; capturing respective landing gear with each tow vehicle; coordinating simultaneous lifting of the aircraft; executing omnidirectional maneuvering patterns; and completing aircraft repositioning. The method may be implemented across various autonomy levels, from manual control to fully autonomous operation, and may incorporate the use of a support platform for distributed weight support.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1A illustrates a perspective view of a tow vehicle, according to aspects of the present disclosure.

FIG. 1B illustrates a top view of the tow vehicle of FIG. 1A.

FIG. 1C illustrates a side view of the tow vehicle of FIG. 1A.

FIG. 2A illustrates a top view of a turntable lifting unit, according to aspects of the present disclosure.

FIG. 2B illustrates a top view of the turntable lifting unit of FIG. 2A with an open gate.

FIG. 2C illustrates a perspective view of the turntable lifting unit of FIG. 2A with an open gate.

FIG. 3 illustrates a flowchart for an autonomous aircraft capturing and lifting process, according to aspects of the present disclosure.

FIG. 4 illustrates a flowchart for an autonomous pushback process, according to aspects of the present disclosure.

FIG. 5 illustrates a top view diagram of an airport layout and autonomous pushback operation, according to aspects of the present disclosure.

FIG. 6 illustrates a multi-vehicle omnidirectional aircraft maneuvering system, according to aspects of the present disclosure.

FIG. 7 illustrates a multi-vehicle omnidirectional aircraft maneuvering system with a support platform.

FIG. 8 illustrates a flowchart for a method for omnidirectional aircraft maneuvering using multiple vehicles, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure provides an autonomous system for capturing, lifting, and pushing back aircraft using a tow vehicle equipped with an integrated turntable lifting unit, sensor fusion system, and controller. This system is designed to enhance the efficiency and precision of aircraft ground handling operations, reducing the risk of damage to aircraft and minimizing the need for manual labor.

The automated 360° turntable lifting unit is a key component of the system, designed to rotate and lift for attachment to a wide range of single and double nose-wheel aircraft configurations. This unit allows the tow vehicle to attach to the aircraft's nose landing gear (NLG) directly from any side of the aircraft, eliminating the need for an exit route and increasing the utilization of space.

The sensor fusion system, integrated with the turntable lifting unit, comprises multiple sensor technologies, such as high-resolution camera sensors, ultrasonic sensors, radar sensors, and laser sensors. These sensors work in unison to detect the NLG and guide the tow vehicle during operations. In some embodiments, the sensor fusion system can also detect pushback lines and other markings on the ground or tarmac, human gestures, environmental conditions, and obstacles, facilitating autonomous pushback operations.

The controller processes data from the sensor fusion system and controls the turntable lifting unit to automatically adjust the position of the tow vehicle relative to the NLG. In some embodiments, the controller includes an artificial intelligence/machine learning component trained on real-world conditions to facilitate autonomous decision-making during pushback operations.

Together, these components form a comprehensive system for autonomous aircraft capturing, lifting, and pushback, offering significant improvements over conventional aircraft ground handling methods.

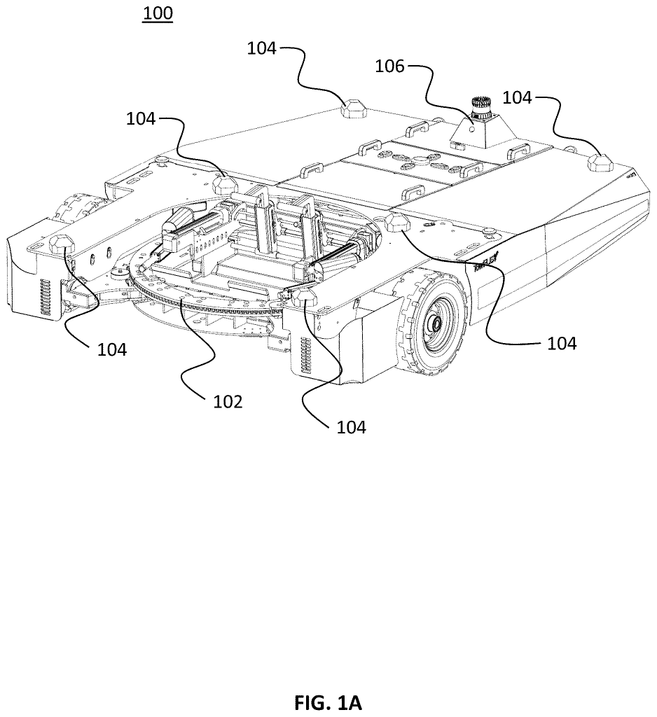

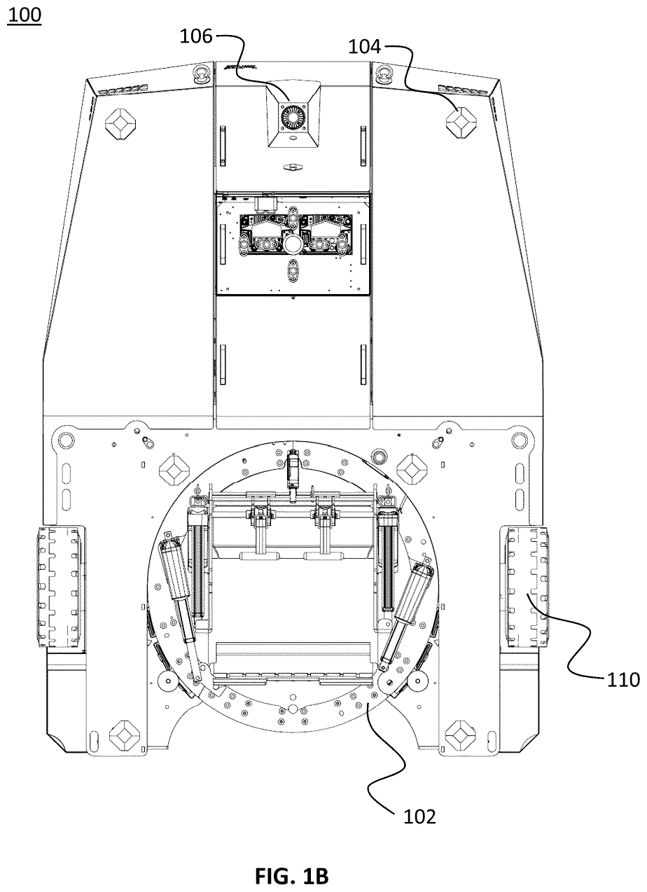

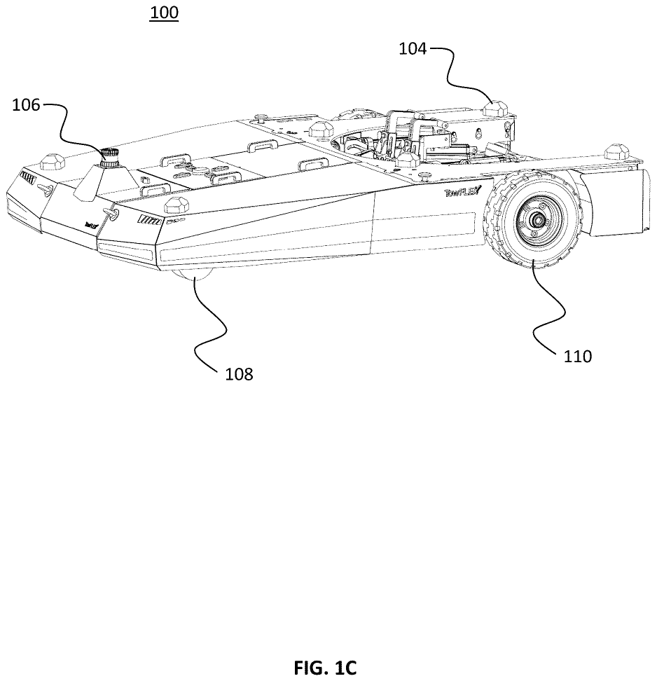

Referring to FIG. 1A, the tow vehicle 100 is depicted in a perspective view. The tow vehicle 100 has a main body with a generally rectangular shape and rounded corners. This design may provide stability and maneuverability during operations. The body of the tow vehicle 100 includes a central opening or cavity in its upper surface. This cavity may house internal mechanisms or components, such as the turntable lifting unit, sensor system, and controller, which contribute to the functionality of the tow vehicle 100.

The tow vehicle 100 incorporates multiple sensors 104 and sensors 106 positioned at various points around its body. In some aspects, these sensors 104 and 106 may be used for environmental awareness and navigation. For example, sensors 104 may be used to sense and monitor the NLG, the positioning of the tow vehicle 100 relative to the aircraft, and/or the presence of obstacles or hazards around the aircraft. In some cases, sensors 106 may be used to detect pushback lines and other markings on the ground or tarmac, human gestures, environmental conditions, and/or obstacles, such as other aircraft, to facilitate autonomous pushback operations.

In some aspects, the tow vehicle 100 may be manually controlled by a human operator through wired or wireless means, allowing for direct control of its movements and functions. This manual control mode may be useful in situations that require human judgment or in environments where autonomous operation is not feasible or desired.

In other embodiments, the tow vehicle 100 may operate in a semi-autonomous mode. In this mode, the system may require only minimal input from a human operator to initiate operations and provide high-level instructions. For example, an operator may input a destination or a specific task, and the tow vehicle 100 may then autonomously execute the necessary movements and actions to complete the task, while still allowing for human oversight and intervention if needed.

In still other embodiments, the tow vehicle 100 may be capable of fully autonomous operation. In this mode, the vehicle may perform complex aircraft handling tasks, including capturing, lifting, and pushing back aircraft, without direct human control. The autonomous mode may utilize the sensor fusion system, controller, and other integrated components to navigate the airport environment, make decisions, and execute operations based on pre-programmed algorithms and real-time data analysis.

Referring to FIG. 1B, the tow vehicle 100 is depicted in a top view, providing a clear view of the sensor system. The sensor system comprises multiple sensors 104 and sensors 106, which may be strategically positioned around the tow vehicle 100. This positioning may allow for comprehensive environmental awareness and navigation during operations. The sensor system of the tow vehicle 100 can be configured to detect a type of aircraft and/or the nose landing gear (NLG) of an aircraft. This detection capability supports the autonomous capturing and lifting process, as it enables the tow vehicle 100 to accurately locate and secure the NLG.

The sensor system comprises at least one of a camera sensor, an ultrasonic sensor, a radar sensor, or a laser sensor. These different types of sensors may work in unison to provide a comprehensive sensing capability. For example, camera sensors may capture high-resolution images of the aircraft, its NLG, and the surrounding environment, while ultrasonic sensors may measure the distance between the tow vehicle 100 and the NLG. Radar sensors may detect the presence of obstacles or hazards around the aircraft, and laser sensors may provide precise measurements of the NLG dimensions. In some embodiments, the sensor system may include additional sensors or different types of sensors, depending on the specific requirements of the aircraft capturing and lifting process.

The data collected by the sensor system is processed by a controller of the tow vehicle 100. The controller determines the position of the aircraft and its NLG based on the sensor data and controls the turntable lifting unit to automatically adjust the position of the tow vehicle 100 relative to the NLG. This autonomous adjustment capability allows the tow vehicle 100 to accurately align with the NLG, facilitating the capturing and lifting process.

In some aspects, the controller of the tow vehicle may be embodied as a combination of hardware and software components integrated within the tow vehicle's systems. The controller may include a central processing unit (CPU) or microprocessor, memory modules, and various input/output interfaces. The software component may comprise firmware, operating systems, and application-specific programs designed to process sensor data, make decisions, and control the tow vehicle's operations.

The controller may be connected to the Controller Area Network (CAN) bus system of the tow vehicle. This connection may allow the controller to communicate with and control various components of the tow vehicle, including the turntable lifting unit, drive systems, and sensor arrays. The CAN bus may facilitate real-time data exchange between different modules of the tow vehicle, enabling coordinated and efficient operation of all systems.

In some implementations, the controller may interface with one or more additional communication devices to enhance its connectivity and functionality. These communication devices may include wireless modules supporting various protocols such as Wi-Fi, cellular networks, or radio frequency (RF) communication. For example, a Wi-Fi module may allow the controller to connect to local networks at airports or maintenance facilities, potentially enabling remote monitoring and control of the tow vehicle. A cellular modem may provide wide-area network connectivity, allowing the controller to receive updates, transmit operational data, or communicate with remote operators over long distances. RF communication modules may enable short-range, low-latency communication with other ground support equipment or control towers.

The integration of these wireless communication capabilities may allow the controller to receive real-time instructions, update its operational parameters, or transmit status information to remote monitoring systems. In some cases, this may enable remote operation or supervision of the tow vehicle, enhancing its flexibility and utility in various airport environments.

In some embodiments, sensors 106 may be configured as 360-degree sensors, providing a complete view of the surrounding environment. This capability may be particularly useful during pushback operations, where the tow vehicle 100 needs to navigate through complex airport environments. The 360-degree sensors may detect pushback lines, other markings on the ground or tarmac, human gestures, environmental conditions, and obstacles, such as other aircraft.

In some implementations, the 360-degree sensors may utilize Light Detection and Ranging (LiDAR) technology. A LiDAR sensor may emit laser pulses in a 360-degree horizontal plane around the tow vehicle, measuring the time it takes for the pulses to reflect off surrounding objects and return to the sensor. This may allow the sensor to create a detailed 3D map of the environment in real-time.

The LiDAR sensor may be mounted on top of the tow vehicle, potentially providing an unobstructed view of the surroundings. It may rotate rapidly, sending out thousands of laser pulses per second to build a comprehensive point cloud of the area. This point cloud data may be processed by the controller to identify objects, determine their distance and position relative to the tow vehicle, and detect potential obstacles or hazards.

In some aspects, the 360-degree LiDAR sensor may work in conjunction with other sensor types to enhance the overall sensing capabilities of the tow vehicle. For example, the LiDAR data may be fused with information from cameras or radar sensors to provide a more robust and accurate representation of the environment. This sensor fusion approach may help overcome limitations of individual sensor types, such as the ability to detect objects in low-light conditions or distinguish between different types of ground markings.

The 360-degree sensor may also incorporate advanced filtering algorithms to differentiate between static and moving objects in the environment. This capability may be particularly useful in busy airport settings, where the tow vehicle needs to navigate around both stationary obstacles and moving vehicles or personnel.

In some implementations, the sensor fusion system may connect to, communicate with, or otherwise integrate with external sensor systems at the airport or on the aircraft carrier. These external sensor systems may include camera systems, LiDAR sensors, GPS tracking systems, or other systems for monitoring the position and movement of objects in the surrounding environment. The sensor fusion system may leverage information gleaned from these other systems and/or coordinate with them directly for obstacle avoidance, safety compliance, autonomous decision making, operations management, and the like.

External sensor systems may be implemented at fixed locations such as on towers, buildings, or runways. For example, high-resolution cameras mounted on airport terminals may provide a wide-angle view of the tarmac, allowing for real-time tracking of multiple aircraft and ground vehicles simultaneously. LiDAR sensors installed along taxiways may create detailed 3D maps of the area, helping to identify potential obstacles or changes in the environment.

In some aspects, external sensor systems may also be implemented on mobile platforms. Tow vehicles 100 equipped with the sensor fusion system may maintain constant communication with each other and/or one or more support vehicles. These support vehicles may take the form of autonomous or semi-autonomous ground vehicles as well as aircraft like drones.

The ground vehicles or drones may be configured to dock with the tow vehicle 100, and, when needed, separate from the tow vehicle 100 to provide additional monitoring capabilities. These capabilities may be especially advantageous during autonomous pushback operations where the aircraft itself creates certain blind spots for the sensors on the tow vehicle 100. The support vehicles may be configured to cover these blind spots as well as provide an additional layer of visibility to other vehicles and personnel in the vicinity.

In some implementations, support vehicles may be equipped with flashing lights or other visual indicators to enhance their visibility. This feature may help alert other ground personnel or vehicles to the presence of the tow vehicle 100 and its one or more support units, thereby improving overall safety in busy airport environments.

The integration of external sensor systems with the tow vehicle's sensor fusion system may allow for a more comprehensive and accurate understanding of the operational environment. For instance, data from fixed cameras on airport buildings may be combined with real-time information from the tow vehicle's onboard sensors and mobile support units to create a multi-layered, dynamic representation of the surroundings. This enhanced situational awareness may enable more efficient and safer autonomous operations.

In some cases, the communication between the tow vehicle and external sensor systems may be facilitated through a centralized control system. This system may act as a hub, collecting and processing data from various sources and distributing relevant information to individual tow vehicles as needed. Such a setup may allow for coordinated movements of multiple tow vehicles and support units, optimizing traffic flow and reducing the risk of conflicts or collisions.

The integration with external sensor systems may also enhance the tow vehicle's ability to adapt to changing environmental conditions. For example, in low visibility situations such as fog or heavy rain, the tow vehicle may rely more heavily on data from fixed LiDAR sensors or radar systems to supplement its own sensor capabilities. This adaptability may allow for continued safe operation in a wider range of weather conditions.

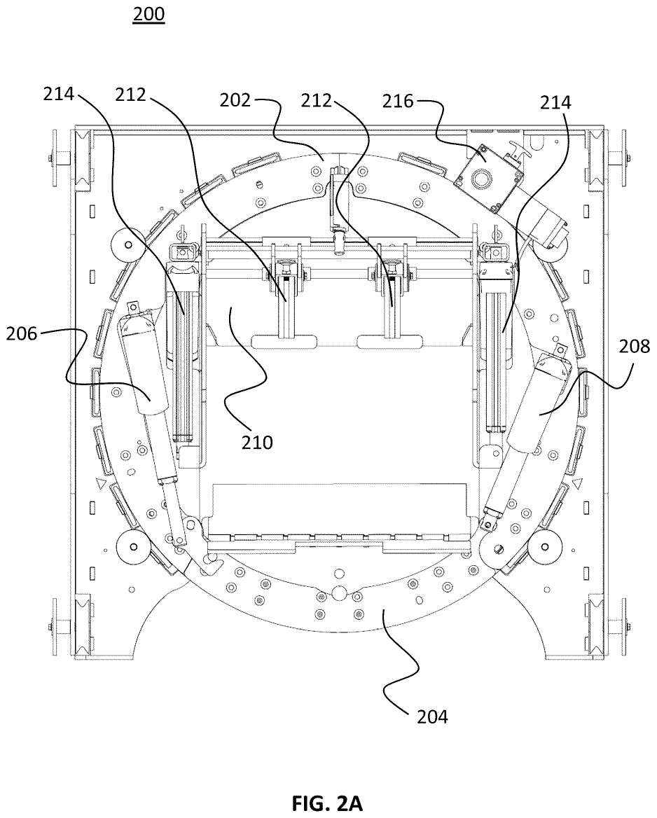

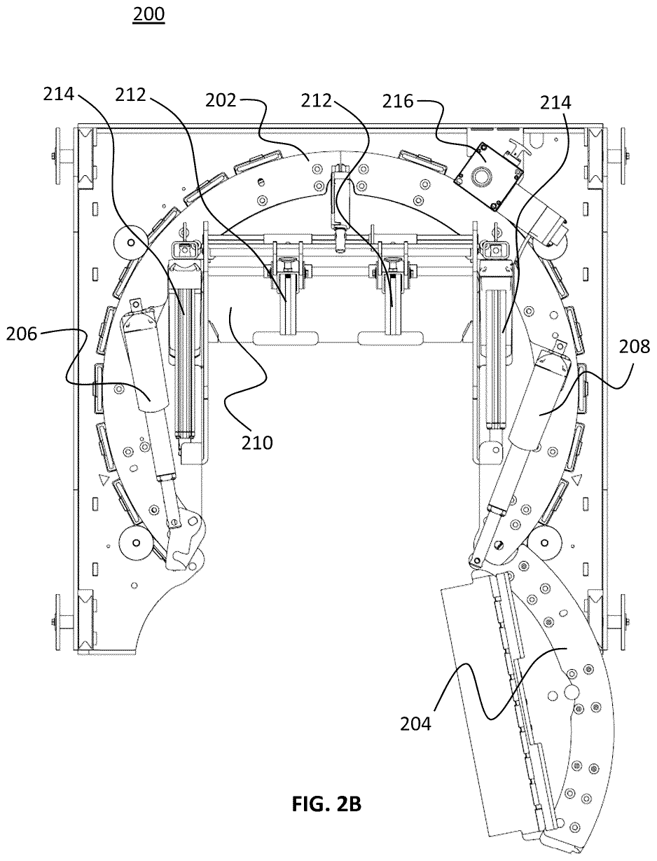

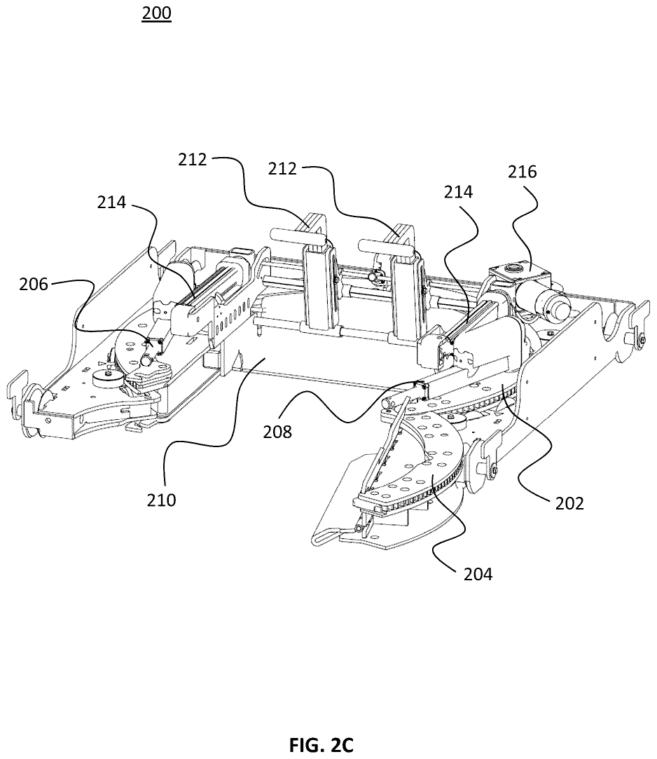

Continuing with the description of FIG. 1B, the tow vehicle 100 includes a turntable lifting unit (TLU) 102 positioned centrally within its body. In some aspects, the TLU 102 is configured to automatically rotate and lift for attachment to a wide range of single and double nose-wheel aircraft configurations. This allows the tow vehicle 100 to attach to the aircraft's NLG directly from any side of the aircraft, eliminating the need for an exit route and increasing the utilization of space. The TLU 102 is described in more detail with respect to TLU 200 in FIGS. 2A, 2B, and 2C.

The tow vehicle 100 may also include a visual line guidance and object recognition system. This system may be configured to detect line markings, objects, or symbols and control the tow vehicle 100 in response. For example, the visual line guidance and object recognition system may detect pushback lines on the ground or tarmac, facilitating autonomous pushback operations. In some cases, the visual line guidance and object recognition system may also detect human gestures, such as hand signals, and control the tow vehicle 100 accordingly.

Referring to FIG. 1C, the tow vehicle 100 is depicted in a side view, providing a clear view of its overall shape and key components. The tow vehicle 100 has a low-profile, elongated body with a tapered front end and a more elevated rear section. The tow vehicle 100 may be configured with two types of wheels for movement. Caster wheels 108 provide maneuverability for steering. The caster wheels 108 may rotate freely in multiple directions, similar to wheels on a shopping cart, allowing for enhanced maneuverability of the tow vehicle 100. In some aspects, these caster wheels 108 may be equipped with a magnetic brake system that operates in the direction of rotation, which corresponds to the direction of vehicle travel.

The magnetic brake system may include electromagnetic components that, when activated, generate a magnetic field to apply braking force to the caster wheels 108. This braking mechanism may be particularly useful in emergency stop situations. In the event that an emergency stop is initiated, the magnetic brakes on the caster wheels 108 may activate to prevent the tow vehicle 100 from turning sideways too quickly if one side of the drive wheels 110 starts to slip.

By applying braking force in the direction of rotation, the magnetic brake system may help maintain the stability and control of the tow vehicle 100 during rapid deceleration. This feature may enhance the safety of the towing operation by reducing the risk of the tow vehicle 100 skidding or jackknifing during emergency stops or on slippery surfaces. The controller of the tow vehicle 100 may be configured to activate the magnetic brakes on the caster wheels 108 in coordination with the braking of the drive wheels 110. This coordinated braking approach may help ensure a more controlled and stable stop, even in challenging conditions or emergency situations.

Drive wheels 110 can be a part of a drive wheel system and may serve as the main propulsion and steering mechanism for tow vehicle 100. The drive wheel system of the tow vehicle 100 may incorporate two individual drive units, each containing a redundant drive system with twin electrical high-torque rotary drive hub gear motors. These drive units may be positioned on opposite sides of the vehicle, with each unit controlling one of the drive wheels 110. This configuration may allow for independent control of each side of the tow vehicle 100, enabling precise maneuvering and rotation capabilities.

In some aspects, the drive wheel system may be designed to allow the two drive units of the tow vehicle 100 to operate independently. This independent operation may be achieved by controlling the rotation direction and speed of each drive wheel 110 separately. For example, to rotate the tow vehicle 100 in place, the controller may command one drive wheel 110 to rotate in a forward direction while simultaneously commanding the opposite drive wheel 110 to rotate in a reverse direction. This opposing rotation of the drive wheels 110 may create a pivoting effect, allowing the tow vehicle 100 to turn on its central axis without forward or backward movement.

The ability to rotate in place may be particularly advantageous in confined spaces such as crowded airport aprons or narrow hangars. This feature may allow the tow vehicle 100 to maneuver efficiently around obstacles and position itself precisely relative to aircraft, potentially improving the overall efficiency of ground handling operations.

In some implementations, the drive wheel system may include variable speed control for each drive wheel 110. This variable speed control may allow for more nuanced movements, such as gradual turns or slight adjustments in position. The controller may adjust the speed of each drive wheel 110 independently based on input from the sensor system, potentially enabling smooth and precise movements during aircraft capturing, lifting, and pushback operations.

The drive wheel system may also incorporate advanced traction control features. In some cases, the controller may monitor the rotation speed of each drive wheel 110 and adjust power delivery to prevent wheel slip. This traction control capability may be particularly useful when operating on wet or slippery surfaces, potentially enhancing the safety and reliability of the tow vehicle 100 in various weather conditions.

In some aspects, the tow vehicle 100 may be configured with two or more drive wheels 110 on each side to enhance traction, stability, and load-bearing capacity. This configuration may distribute the weight of the tow vehicle 100 and the aircraft more evenly across multiple points of contact with the ground.

The multiple drive wheels 110 on each side may be arranged in a tandem configuration, where they are aligned one behind the other. This arrangement may allow the tow vehicle 100 to maintain a relatively narrow profile while still benefiting from increased traction and load distribution. In some implementations, the drive wheels 110 may be mounted on independent suspension systems, enabling them to adapt to uneven surfaces and maintain consistent ground contact.

Each of the drive wheels 110 in this multi-wheel configuration may be powered by its own electric motor, potentially allowing for even more precise control over the tow vehicle's movement. The controller of the tow vehicle 100 may be programmed to coordinate the operation of these multiple drive wheels 110, adjusting the power output to each wheel based on factors such as the weight distribution of the aircraft, the surface conditions, and the desired maneuver.

In some cases, the use of multiple drive wheels 110 on each side may enable the tow vehicle 100 to handle heavier aircraft or operate in more challenging environmental conditions. For example, this configuration may provide better traction on wet or icy surfaces, or when moving aircraft on inclined surfaces such as those found on some aircraft carriers.

The multi-wheel design may also contribute to the redundancy and reliability of the tow vehicle 100. If one drive wheel 110 or its associated motor were to malfunction, the remaining wheels could potentially continue to provide sufficient propulsion and control to complete the aircraft handling operation or move the tow vehicle 100 to a safe location for maintenance.

Referring to FIG. 2A, the turntable lifting unit (TLU) 200 is depicted in a top view, providing a clear view of its key components and their functions in capturing, securing, and manipulating the aircraft's NLG. The TLU 200 may be integrated into various configurations to accommodate different operational needs and environments. While the TLU 200 is shown as part of the tow vehicle 100 in FIG. 1A, FIG. 1B, and FIG. 1C, it may also be implemented in other forms.

In some aspects, the TLU 200 may be designed as standalone equipment. This configuration may allow for greater flexibility in deployment and use across different airport or carrier environments.

As a standalone unit, the TLU 200 may be equipped with its own power source, sensor system, control systems (including, for example, the controller described above), and mobility features, enabling it to operate independently of a larger vehicle.

In other implementations, the TLU 200 may be combined with or attached to a towbar. This configuration may provide a hybrid solution that leverages the traditional towbar approach while incorporating the advanced capturing and lifting capabilities of the TLU 200. The towbar-TLU combination may offer enhanced maneuverability and precision in aircraft handling, particularly in situations where a full tow vehicle is not required or practical.

Additionally, the TLU 200 may be combined with or attached to different types of vehicles or trailers. This versatility allows for integration with existing ground support equipment or specialized vehicles used in various aviation contexts. For example, the TLU 200 may be mounted on a compact electric vehicle for use in tight hangar spaces, or it may be integrated into a larger, more robust vehicle for outdoor operations in challenging weather conditions.

The sensor system and control mechanisms of the TLU 200 may be adapted to suit each of these configurations. For standalone or towbar-attached implementations, additional sensors or control interfaces may be incorporated to ensure safe and efficient operation without the support of a full tow vehicle. When combined with different vehicles or trailers, the TLU's control systems may be integrated with the host vehicle's systems to provide seamless operation and enhanced functionality.

These various implementations of the TLU 200 may expand its applicability across a wide range of aircraft handling scenarios, from small regional airports to large international hubs, and from traditional ground operations to specialized military applications. The flexibility in configuration may allow operators to select the most appropriate implementation based on their specific needs, infrastructure, and operational constraints.

The automated turntable 202 may form a central part of TLU 200, providing a rotational platform. The automated turntable 202 may be designed to provide precise 360-degree rotation capabilities, allowing for flexible positioning of the aircraft's NLG. This rotational capability may be achieved through the use of a high-precision electric motor coupled with a gear reduction system. The gear reduction system may allow for smooth and controlled rotation, even when under the load of an aircraft.

In some implementations, the automated turntable 202 may utilize a large diameter bearing to support the rotational movement. This bearing may be designed to handle both the vertical loads from the aircraft's weight and the horizontal loads that may occur during towing operations. The outer race of this bearing may be fixed to the frame of the TLU 200, while the inner race may be connected to the rotating platform that supports the aircraft's NLG.

The rotational movement of the automated turntable 202 may be controlled by a servo system that provides precise position control. This servo system may include a motor driver that interprets commands from the main controller and translates them into the appropriate voltage and current signals to drive the motor. The motor may be equipped with an integrated brake system that can hold the turntable in position when rotation is not required, providing additional safety and stability.

To monitor and control the positioning of the automated turntable 202, an absolute encoder 216 may be incorporated into the system. The absolute encoder 216 may provide continuous, high-resolution feedback on the exact angular position of the turntable. Unlike incremental encoders that only measure relative movement, an absolute encoder can determine the turntable's position immediately upon startup, without requiring a homing or reference move.

In some aspects, the absolute encoder 216 may utilize a multi-turn design, allowing it to track multiple complete rotations of the turntable. This feature may be particularly useful in applications where the turntable needs to rotate through multiple revolutions during operation. The absolute encoder 216 may communicate with the system's controller using a digital interface, such as SSI (Synchronous Serial Interface) or BiSS (Bidirectional Serial Synchronous Interface), providing fast and reliable position data.

The controller may use the data from the absolute encoder 216 to implement closed-loop control of the turntable's position. This control system may allow for extremely precise positioning, potentially achieving accuracy within fractions of a degree. The controller may also use this position data to implement motion profiles for smooth acceleration and deceleration of the turntable, reducing wear on the system and providing a more stable platform for the aircraft's NLG.

In some implementations, the system may include multiple redundant absolute encoders to enhance reliability and safety. These redundant encoders may be compared in real-time to detect any discrepancies that could indicate a sensor failure or other system issue.

The combination of the high-precision motor, gear reduction system, and absolute encoder feedback may allow the automated turntable 202 to achieve both rapid rotation for efficient aircraft positioning and extremely fine adjustments for precise alignment. This capability may be particularly useful in confined spaces or when aligning the aircraft with specific ground markings or equipment.

TLU 200 includes a gate 204, which can serve as an entry and exit point for the TLU 200. Adjacent to the gate 204, on either side, are lock actuators 206 and gate actuators 208. These actuators are responsible for the operation and locking mechanism of the gate 204. In some cases, the gate 204 is configured to automatically unlock, open to receive the NLG, close to secure the NLG, and lock.

In some implementations, the actuators used in the TLU 200, such as the lock actuators 206, gate actuators 208, and moving floor actuators 214, may be entirely electrical. This configuration may eliminate the need for hydraulic systems, potentially offering several advantages.

Electrical actuators may provide precise control and positioning capabilities, allowing for smooth and accurate movements of the gate 204, moving floor 210, and other components. The use of electrical actuators may also eliminate concerns associated with hydraulic systems, such as fluid leaks, pressure loss, or temperature-related performance variations. This may result in a more environmentally friendly system, as there is no risk of hydraulic fluid contamination. Additionally, electrical actuators may require less maintenance compared to hydraulic systems, potentially reducing downtime and operational costs.

In some aspects, electrical actuators may offer improved energy efficiency, as they may only consume power when actively moving or holding a position. This characteristic may contribute to the overall energy efficiency of the tow vehicle 100 or standalone TLU 200, potentially extending operational time between charges for battery-powered implementations.

The electrical actuators may be designed with built-in position feedback mechanisms, allowing for real-time monitoring of their status and position. This feature may enhance the system's ability to detect and respond to any irregularities or malfunctions, potentially improving overall reliability and safety.

In some cases, the use of electrical actuators may allow for a more compact and lightweight design of the TLU 200. This may be particularly advantageous in applications where space or weight constraints are significant factors, such as in compact tow vehicles or portable systems.

In some implementations, the TLU 200 may incorporate an emergency gate release mechanism to allow manual opening of the gate 204 in the event of a power failure or system malfunction. This feature may enhance the safety and reliability of the TLU 200 by providing a backup method for releasing an aircraft's NLG in emergency situations.

The emergency gate release mechanism may be designed as a mechanical system that can be operated without electrical power. In some aspects, this mechanism may include a manual lever or handle located on the exterior of the TLU 200, easily accessible to ground personnel. When activated, this lever may disengage the lock actuators 206 and override the gate actuators 208, allowing the gate 204 to be opened manually.

In some aspects, the emergency gate release mechanism may be designed with a fail-safe approach, where the loss of power automatically triggers the release of the locking mechanism. This design may ensure that the gate 204 can be opened manually even if the emergency release lever is not immediately accessible or operable.

The TLU 200 incorporates a moving floor 210, which can be a segmented platform capable of horizontal and vertical movement. This moving floor 210 can be controlled by the moving floor actuators 214, positioned at opposite corners of the unit. In some embodiments, the moving floor 210 is configured to adjust to accommodate different nose wheel sizes. In some aspects, the moving floor 210 may be configured to automatically slide under the NLG wheel or wheels, working in conjunction with the NLG clamps 212 to effectively “grab”the NLG from both the top and bottom.

The moving floor 210 may incorporate a self-locking mechanism to prevent unintended movement under mechanical loads. This feature may enhance the safety and stability of the TLU 200 during aircraft handling operations. In some implementations, the self-locking mechanism may employ a brake system integrated with the moving floor actuators 214. This brake system may automatically engage when the actuators are not in operation, securing the moving floor 210 in its current position. The brakes may be designed to hold the full weight of the aircraft's NLG, ensuring that the moving floor 210 remains stationary even under maximum load conditions.

The control system of the TLU 200 may monitor the status of the self-locking mechanism, ensuring that it is properly engaged before allowing any load to be placed on the moving floor 210. This integration may provide an additional safety check in the aircraft handling process, potentially reducing the risk of accidents or equipment damage.

The operation of the moving floor 210 may involve a series of coordinated movements. As the TLU 200 surrounds the NLG, the moving floor 210 may extend outward, positioning itself beneath the NLG wheels. This extension may be controlled by the moving floor actuators 214, which may provide precise horizontal movement of the floor segments.

Once the moving floor 210 is properly positioned under the NLG wheels, the moving floor 210 may then function as an elevator mechanism. In this phase of operation, the moving floor actuators 214 may control the vertical movement of the floor, lifting the NLG off the ground. This lifting action may be synchronized with the overall operation of the TLU 200, allowing for a smooth and controlled elevation of the aircraft's nose.

The ability of the moving floor 210 to adjust to different nose wheel sizes may enhance the versatility of the TLU 200. This adaptability may be achieved through the use of segmented floor panels that can be individually controlled or through a flexible floor design that can conform to various wheel diameters.

In some implementations, sensors integrated into the moving floor 210 may detect the weight and position of the NLG wheels, providing feedback to the control system. This feedback may allow for real-time adjustments to the floor position and lifting force, ensuring optimal support and stability throughout the capturing and lifting process.

The moving floor 210, in combination with other components of the TLU 200, may contribute to a fully autonomous and precise method of aircraft handling. This system reduces the need for manual intervention, enhances safety, and improves the efficiency of ground operations in various aviation environments.

After the NLG has been lifted, the NLG clamps 212 may engage from above, securing the upper portion of the NLG. The combination of the moving floor 210 supporting from below and the NLG clamps 212 securing from above may create a stable and secure hold on the NLG.

One or more NLG clamps 212 (also referred to as nose wheel adapters) may be used to secure an aircraft's NLG. The NLG clamps 212 are positioned on opposite sides of the automated turntable 202. In some cases, the NLG clamps 212 are configured to automatically position themselves to hold down the NLG when weight is detected on the moving floor 210. The NLG clamps 212 may include electro-cylinders connected to the CAN bus.

The NLG clamps 212 may be operated by fully electric actuators and controlled by the controller to provide precise and efficient securing of the aircraft's NLG. In some implementations, each NLG clamp 212 may be equipped with its own dedicated electric actuator, allowing for independent control and movement of each clamp.

The electric actuators for the NLG clamps 212 may utilize high-torque servo motors coupled with precision gear systems. These motors may provide the necessary force to securely clamp the NLG while also allowing for fine adjustments in positioning. The gear systems may enable smooth and controlled movement of the clamps, potentially reducing wear on both the clamps and the aircraft's landing gear.

In some aspects, the controller may utilize feedback from various sensors to determine the optimal positioning and clamping force for the NLG clamps 212. These sensors may include load cells to measure the weight distribution on the moving floor 210, proximity sensors to detect the exact position of the NLG, and force sensors within the clamps themselves to monitor the applied pressure.

In some cases, the NLG clamps 212 may automatically adjust to accommodate different NLGs for various types of aircraft. This adjustment may be based on data from sensors 104 and/or sensors 106, which may identify the type of aircraft and/or the precise dimensions and configurations of the NLG. This adaptive capability may enable the TLU 200 to handle a wide range of aircraft types efficiently.

The controller may implement closed-loop control algorithms to manage the operation of the NLG clamps 212. When weight is detected on the moving floor 210, the controller may initiate a sequence to position the clamps. This sequence may involve gradually closing the clamps while continuously monitoring sensor feedback to ensure proper alignment and contact with the NLG.

In some implementations, the controller may automatically adjust the clamping force dynamically based on the aircraft's weight and environmental conditions. For example, in windy conditions, the controller may increase the clamping force to provide additional stability. The electric actuators may allow for rapid adjustments in response to changing conditions or operational requirements.

The controller may also coordinate the operation of the NLG clamps 212 with other components of the TLU 200. For instance, the clamping process may be synchronized with the movement of the gate 204 and the adjustment of the moving floor 210 to ensure a smooth and efficient capture of the NLG.

In some cases, the electric actuators for the NLG clamps 212 may incorporate built-in position encoders. These encoders may provide real-time feedback on the exact position of each clamp, allowing the controller to maintain precise control over the clamping process. This feedback may also be used for diagnostic purposes, potentially enabling early detection of any misalignments or mechanical issues.

The use of fully electric actuators for the NLG clamps 212 may offer advantages in terms of maintenance and reliability. These actuators may require less frequent maintenance compared to hydraulic systems, and their performance may be less affected by temperature variations. Additionally, the electric actuators may provide more consistent operation over time, potentially enhancing the overall reliability of the aircraft capturing process.

In some implementations, the controller may include safety features specifically designed for the operation of the NLG clamps 212. These features may include torque limiting to prevent over-clamping, obstacle detection to avoid potential collisions during clamp movement, and emergency release functions that can quickly disengage the clamps if necessary.

Referring to FIG. 2B, the TLU 200 is depicted in a top view, providing a view of its components and their functions in capturing, securing, and manipulating the aircraft's NLG. The gate 204 in FIG. 2B is shown in an open position, allowing for the entry of the aircraft's NLG into the TLU 200.

The gate 204 is coupled to the automated turntable 202 and is configured to automatically unlock and open to receive the NLG. Once the NLG is positioned within the TLU 200, the gate 204 is configured to close and secure the NLG. The gate 204 is then locked to ensure the secure attachment of the NLG to the TLU 200.

Adjacent to the gate 204, on either side, are lock actuators 206 and gate actuators 208. These actuators are responsible for the operation and locking mechanism of the gate 204. The lock actuators 206 are configured to engage and disengage the locking mechanism of the gate 204, ensuring that the gate 204 remains securely closed during the aircraft capturing and lifting process. The gate actuators 208 are responsible for the opening and closing operations of the gate 204.

The autonomous operation of the gate 204 and its associated actuators 206 and 208 contributes to the overall efficiency and safety of the aircraft capturing and lifting process. By automating these operations, the need for manual intervention is reduced, minimizing the risk of human error and potential damage to the aircraft's NLG. Furthermore, the autonomous operation of the gate 204 allows for rapid and precise capturing and lifting of the aircraft, enhancing the overall efficiency of the aircraft ground handling operations.

Referring to FIG. 2C, the TLU 200 is depicted in a perspective view. The integration of the components described above may enable a series of autonomous processes for adjusting to, securing, and lifting the aircraft's NLG. The system may first use sensor data to determine the approaching aircraft's NLG configuration. Based on this information, the moving floor 210 and NLG clamps 212 may adjust to the appropriate positions.

As the aircraft approaches, the gate 204 may open, allowing the NLG to enter the unit. Once the NLG is detected in the correct position, the gate 204 may close and lock, securing the NLG within the unit. The moving floor 210 may then make fine adjustments to ensure optimal support.

With the NLG properly secured, the automated turntable 202 may initiate the lifting process, while the NLG clamps 212 engage to hold the NLG securely in place. Throughout this process, the absolute encoder 216 may provide continuous feedback to ensure precise control and positioning of all components.

This autonomous sequence may streamline the aircraft capturing and lifting process, potentially reducing the time required for ground operations and minimizing the risk of human error or equipment damage. The design of the TLU 200 may allow for efficient handling of various aircraft types, adapting to different NLG configurations and sizes with minimal manual intervention.

During autonomous pushback processes, the TLU 200 may work in coordination with the tow vehicle's sensor system. As the tow vehicle follows the pushback line and makes turns, the TLU 200 may automatically adjust its position and orientation to maintain the proper alignment of the NLG.

In some cases, the TLU 200 may include additional sensors specifically designed to monitor the orientation of the NLG relative to the aircraft's roll axis. These sensors may provide real-time data that allows the system to make immediate corrections if any misalignment is detected.

The CAN bus may facilitate rapid communication between all components of the TLU 200 and the tow vehicle's control systems. This high-speed data exchange may enable the system to respond quickly to any changes in alignment, ensuring that the NLG remains straight relative to the aircraft's roll axis throughout the pushback and towing operations.

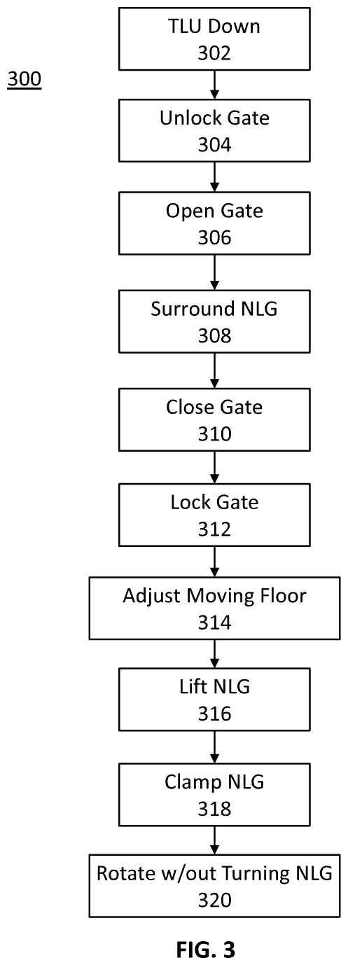

FIG. 3 illustrates an autonomous aircraft capturing process 300 that may involve a sequence of steps for lowering the TLU, securing the NLG, and preparing for aircraft repositioning. The process may begin with step 302, where the TLU is lowered into position. This step may involve adjusting the height of the TLU to align with the aircraft's NLG.

Following the lowering of the TLU, the process may proceed to step 304, where the gate is unlocked. This action may prepare the TLU to receive the aircraft's NLG. Once unlocked, the process may move to step 306, where the gate is opened. The open gate may provide a clear path for the NLG to enter the TLU.

In step 308, the TLU may surround the NLG. This step may involve precise positioning of the TLU around the NLG, using sensor data to guide the alignment.

In some embodiments, the TLU may operate in coordination with the tow vehicle's drive system to automatically maneuver the tow vehicle around the NLG and adjust the TLU accordingly to capture the NLG. This coordinated operation may involve a sophisticated interplay between the tow vehicle's sensors, drive system, and the TLU's components.

The tow vehicle's sensor system, which may include sensors 104 and 106, may continuously scan the environment to detect the position and orientation of the aircraft's NLG. As the tow vehicle approaches the aircraft, the controller may process this sensor data in real-time to determine the optimal path for positioning the TLU around the NLG.

Based on this processed data, the controller may send commands to the tow vehicle's drive system, which may include the drive wheels 110. These commands may direct the tow vehicle to execute precise movements, potentially including forward, backward, and rotational maneuvers. The drive system may utilize its independent wheel control to perform these movements with a high degree of accuracy.

As the tow vehicle maneuvers, the TLU may simultaneously adjust its components in preparation for NLG capture. The gate 204 may open at the appropriate time, guided by the gate actuators 208. The moving floor 210 may adjust its position using the moving floor actuators 214, preparing to receive the NLG. The NLG clamps 212 may also pre-position themselves based on the anticipated NLG configuration.

The controller may continuously update these adjustments as the tow vehicle approaches the NLG, using feedback from the absolute encoder 216 and other sensors to ensure precise alignment. In some cases, the automated turntable 202 may rotate to achieve the optimal orientation for NLG capture.

In some implementations, the system may utilize machine learning algorithms to optimize this coordinated operation. These algorithms may analyze data from previous capture operations to refine the maneuvering and adjustment processes, potentially improving efficiency and accuracy over time.

The seamless coordination between the tow vehicle's drive system and the TLU may allow for swift and precise NLG capture, potentially reducing the time required for aircraft handling operations. This autonomous approach may also enhance safety by minimizing the need for personnel to be in close proximity to the aircraft during the capture process.

Once the NLG is properly positioned within the TLU, the process may advance to step 310, where the gate is closed. This action may be followed by step 312, where the gate is locked, securing the NLG within the TLU.

After the NLG is enclosed and secured, the process may proceed to step 314, where the moving floor is adjusted. This adjustment may accommodate the specific dimensions and configuration of the captured NLG. In some aspects, the moving floor may be designed to slide under the NLG in a manner similar to a wedge, providing pressure on the opposite side of the NLG wheel(s) as the gate.

Once the NLG is positioned on the moving floor 210 and the gate 204 is closed and locked, the system may initiate the lifting process at step 316. The moving floor actuators 214 may raise the entire floor assembly, including the captured NLG. This lifting action may raise the aircraft's nose so that it can be clamped and fully secured prior to any towing and/or pushback operations.

In step 318, the NLG may be clamped (e.g., with NLG clamps 212), providing additional security and stability at the top of the NLG.

The final step in the process, step 320, may involve rotating the TLU without turning the NLG, i.e., the tow vehicle can turn in place while maintaining the orientation of the TLU and the captured NLG. This capability may enable the tow vehicle to begin pulling the aircraft in any direction without applying undue stress to the NLG.

The tow vehicle may utilize its drive system, which may include independently controlled drive wheels, to execute a rotation around its vertical axis. During this rotation, the TLU may remain stationary relative to the aircraft, potentially preventing any twisting forces from being applied to the NLG. This feature may be particularly useful in confined spaces or when precise aircraft positioning is required.

In some implementations, the controller may coordinate the rotation of the tow vehicle with real-time feedback from the absolute encoder and other sensors within the TLU. This coordination may help ensure that the orientation of the NLG remains constant throughout the rotation process. The system may make continuous micro-adjustments to compensate for any slight deviations, potentially maintaining the alignment between the aircraft and the tow vehicle.

The ability to rotate without turning the NLG may offer several potential benefits. It may reduce wear and tear on the aircraft's landing gear by minimizing lateral forces during maneuvering. This feature may also enhance operational flexibility, allowing the tow vehicle to reposition itself relative to the aircraft without the need for complex multi-point turns or disconnecting and reconnecting the NLG.

In some cases, this rotational capability may be combined with the tow vehicle's visual line guidance and object recognition system. The system may detect obstacles or markings in the surrounding environment and use this information to guide the rotation process. This integration may allow for precise alignment with taxiway lines or positioning within tight hangar spaces.

The rotation without NLG turning feature may also contribute to the overall efficiency of ground operations. It may allow for quicker aircraft repositioning, potentially reducing turnaround times and improving gate utilization at busy airports. In some implementations, this feature may be particularly valuable for pushback operations, enabling the tow vehicle to align itself with the designated pushback path without placing stress on the aircraft's landing gear.

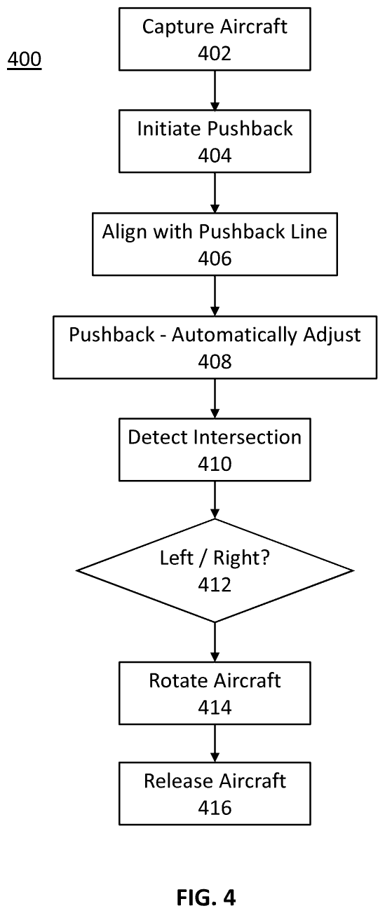

FIG. 4 illustrates an autonomous pushback process 400 that may involve a sequence of steps for capturing an aircraft, initiating pushback, and aligning the aircraft with a pushback line. The process may begin with step 402, where the aircraft is captured by a tow vehicle (e.g., an autonomous or semi-autonomous tow vehicle) using the autonomous aircraft capturing process 300 described in FIG. 3. This step may involve securing the aircraft's nose landing gear (NLG) within the turntable lifting unit (TLU) of the tow vehicle.

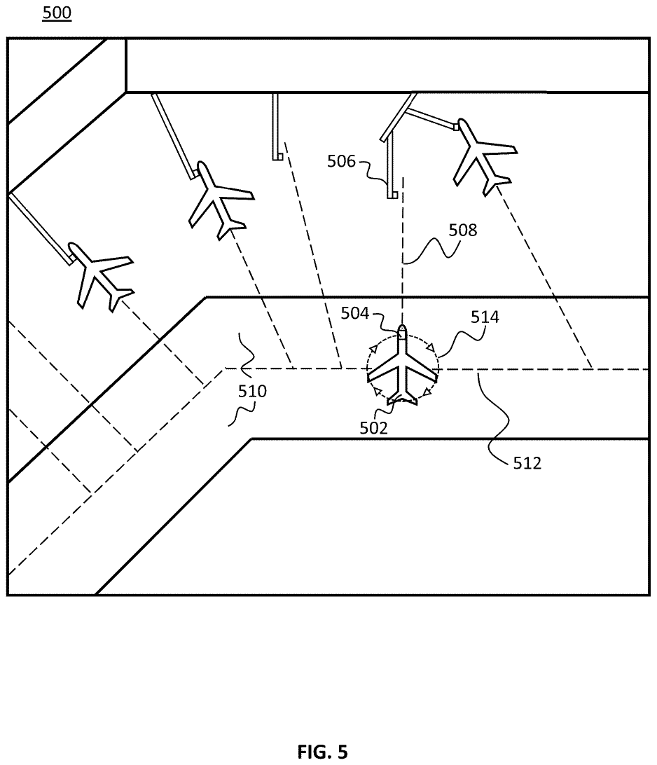

In airports and on aircraft carriers, pushback lines may be used as visual guides for aircraft ground movements, particularly during pushback operations. These lines may be painted or otherwise marked on the ground surface, providing a clear path for aircraft to follow when being pushed back from gates, parking positions, or other stationary locations. FIG. 5, for example, illustrates a sample airport layout 500, including various aircraft 502, tow vehicle 504, passenger gates 506, pushback lines 508, taxiway 510, and centerline 512.

At airports, pushback lines may serve several purposes. They may help guide tow vehicles and aircraft along predetermined routes, ensuring safe clearance from nearby obstacles, other aircraft, and ground equipment. These lines may also assist in maintaining orderly traffic flow on the apron or tarmac, potentially reducing the risk of collisions or congestion.

On aircraft carriers, pushback lines may be particularly crucial due to the limited space available on the flight deck. These lines may guide precise aircraft movements during repositioning operations, helping to optimize the use of available deck space and facilitate efficient launch and recovery operations.

The autonomous navigation of pushback lines by aspects of the disclosure may significantly enhance safety, increase efficiency, and reduce personnel requirements during pushback operations. By utilizing advanced sensor systems and intelligent control algorithms, the tow vehicle may precisely follow pushback lines without constant human guidance.

In terms of safety, the autonomous system may continuously monitor the environment for potential obstacles or hazards using its sensor array. This constant vigilance may reduce the risk of collisions with other vehicles, equipment, or personnel on the tarmac. The system may also maintain a consistent and optimal distance from the aircraft, potentially minimizing the risk of damage to the aircraft or tow vehicle during the pushback process.

Efficiency may be improved in several ways. The autonomous system may execute pushback maneuvers with a high degree of precision and consistency, potentially reducing the time required for each operation. This precision may allow for smoother transitions between different phases of the pushback process, such as initial alignment, straight pushback, and turns at intersections. The system may also optimize the pushback path based on real-time data, potentially adapting to changing conditions on the tarmac more quickly than a human operator.

The reduction in required personnel may also be substantial. Traditional pushback operations often require multiple ground crew members, including a tow vehicle operator, wing walkers, and a person in communication with the flight deck. With autonomous pushback capabilities, many of these roles may be consolidated or eliminated. The system may perform the functions of guidance, obstacle detection, and aircraft alignment without direct human intervention. This reduction in personnel may lead to cost savings for airlines and airport operators, as well as potentially increasing the number of simultaneous pushback operations that can be managed with existing staff levels.

Furthermore, the autonomous system may operate effectively in various weather conditions and visibility levels, potentially maintaining consistent performance in situations where human operators might struggle. This capability may contribute to improved on-time performance and reduced weather-related delays in pushback operations.

The integration of the autonomous pushback system with other airport management systems may further enhance its benefits. For example, the system may coordinate with air traffic control and gate management systems to optimize the timing and routing of pushback operations, potentially improving overall airport efficiency.

Following the capture of the aircraft, the process may proceed to step 404, where the pushback is initiated. In this step, the tow vehicle (e.g., tow vehicle 504) may begin to move, pushing the aircraft (e.g., aircraft 502) away from its parking position (e.g., at passenger gate 506) toward a taxiway or runway (e.g., taxiway 510). The tow vehicle may include a controller configured to receive data from the sensor system, which may comprise sensors 104 and 106. This sensor system may detect the position of the NLG relative to a pushback line (e.g., pushback line 508) on the ground.

In step 406, the tow vehicle in coordination with the TLU may automatically align the aircraft with the pushback line. The controller may process the data from the sensor system to determine the position of the NLG relative to the pushback line. Based on this information, the controller may control the TLU and automatically adjust the position of the tow vehicle relative to the NLG. This adjustment may help maintain alignment of the aircraft with the pushback line during the pushback operation.

In step 408, the autonomous pushback process may involve continuously adjusting the position of the aircraft tow vehicle to maintain alignment of the aircraft with the pushback line. The controller may process real-time data from the sensor system to determine any deviations from the desired alignment. Based on this information, the controller may send commands to the turntable lifting unit and drive systems of the tow vehicle to make fine adjustments to the vehicle's position and orientation.

As the pushback operation continues, the controller may be configured to detect, at step 410, when the main landing gear (MLG) of the aircraft reach an intersection of the pushback line with another line (e.g., a runway or taxiway centerline 512) indicating a turn. This detection may be accomplished through the sensor system or the visual line guidance and object recognition system. The system may use various methods to detect the pushback line and intersections, such as computer vision algorithms, LiDAR technology, or other sensing techniques.

As the pushback operation progresses, the system may continuously monitor for intersections in the pushback line. When an intersection is detected, the controller may analyze the geometry of the intersection to determine the available turn options. This analysis may involve processing data from multiple sensors to create a comprehensive understanding of the intersection layout.

Upon detecting an intersection, the controller may be configured to receive input indicating a turn direction at step 412. This input may come from a human operator (e.g., via a user interface on the tow vehicle or remote control system) or from a pre-programmed pushback plan. In some implementations, the system may also be capable of autonomously determining the appropriate turn direction based on the airport layout and the aircraft's destination, signals or gestures from ground personnel, radio instructions from air traffic control or ground control, and/or instructions from air traffic management systems.

Once the turn direction is determined, the system may initiate the aircraft rotation process in step 414. Based on the detected intersection and the indicated turn direction, the controller may automatically rotate the aircraft in place on its main landing gear (e.g., as illustrated by turn in place operation 514 in FIG. 5). This rotation may be achieved by causing the two sets of MLG wheels to rotate in opposite directions, effecting a stationary turn.

In some implementations, the sensor system may determine how to rotate the aircraft by calculating the distance between the NLG and the MLG. This calculation may be performed using data from various sensors, such as LiDAR, cameras, or ultrasonic sensors, which may provide precise measurements of the aircraft's dimensions and wheel positions.

Once the distance between the NLG and MLG is determined, the controller may use this information to calculate the optimal angle at which the tow vehicle should position itself relative to the aircraft. This positioning may allow the tow vehicle to initiate a turn that causes the wheels of the MLG to rotate in opposite directions.

The tow vehicle may then align itself at the calculated angle. As the tow vehicle begins to move, it may apply force to the NLG in a way that causes the aircraft to pivot around its center of gravity. This pivoting motion may result in the MLG wheels rotating in opposite directions, with one set of wheels moving forward and the other set moving backward.

By initiating the turn in this manner, the system may minimize the lateral forces applied to the MLG wheels. This approach may result in little to no strain on the MLG wheels during the turning process, potentially reducing wear and tear on the aircraft's landing gear components.

The controller may continuously monitor the rotation of the aircraft using its sensor system, making real-time adjustments to the tow vehicle's position and force application as needed. This ongoing adjustment may help maintain the optimal turning angle throughout the rotation process, ensuring smooth and efficient aircraft movement.

In some aspects, the system may also take into account factors such as the aircraft's weight distribution, tire pressure, and surface conditions when calculating the optimal turning strategy. These considerations may allow the system to further refine its approach, potentially resulting in even smoother and more efficient aircraft rotations.

During the rotation, the system may continuously monitor the aircraft's position relative to the new pushback line direction. The controller may make real-time adjustments to ensure a smooth transition onto the new path, potentially using predictive algorithms to anticipate and correct for any deviations.

Throughout the pushback operation, the controller may continuously adjust the position of the tow vehicle to maintain alignment with the pushback line and execute any required turns. This autonomous process may help ensure precise and consistent pushback operations, potentially reducing the risk of errors and improving overall efficiency.

In some implementations, the autonomous pushback process may continue indefinitely, accommodating any number of turns or directional changes, until the pilot of the aircraft assumes control for taxiing or take-off. This extended pushback capability may allow for greater flexibility in aircraft ground movements, potentially enabling more efficient use of airport taxiways and runways.

The tow vehicle may be configured to follow complex pushback paths that may include multiple turns, curves, and straight sections. The visual line guidance and object recognition system may continuously detect and interpret ground markings, allowing the tow vehicle to navigate these paths accurately. In some cases, the system may be capable of following temporary or newly painted lines, adapting to changes in airport layout or traffic flow.

During extended pushback operations, the controller may continuously monitor for potential obstacles or conflicts with other ground traffic. The sensor system may detect other vehicles, equipment, or personnel in the vicinity, and the controller may adjust the pushback path or speed accordingly to maintain safe operations. In some implementations, the system may be integrated with airport traffic management systems, allowing for coordinated movements with other aircraft and ground vehicles.

The autonomous pushback system may also be capable of responding to dynamic instructions from air traffic control or ground control. In some aspects, the system may receive updated routing information in real-time, allowing for on-the-fly adjustments to the pushback path. This flexibility may be particularly useful in busy airport environments where traffic patterns may change rapidly.

Upon completion of the pushback operation, the controller may be further configured to automatically release the aircraft from the tow vehicle in step 416. The controller may first bring the tow vehicle to a complete stop at the designated release point. It may then command the TLU to lower the aircraft's NLG to the ground.

Once the NLG is firmly on the ground, the system may command the gate of the TLU to unlock and open. The tow vehicle may then slowly move away from the aircraft, ensuring that all components are clear of the aircraft's structure. Throughout this release process, the system may continue to monitor the position and status of all components using its sensor array to ensure a safe and controlled release. After the physical separation is complete, the system may perform a final check to confirm that all systems are disengaged and that the tow vehicle is at a safe distance from the aircraft.

The autonomous release process may help streamline the transition from pushback to taxiing, potentially reducing the time required for this phase of ground operations. By automating these steps, the system may also help reduce the risk of errors or miscommunications that could occur during a manual handover process.

As discussed above, the autonomous aircraft capturing and lifting system may incorporate advanced control and sensing capabilities to enhance its performance in aircraft handling and towing operations. The controller may integrate data from multiple sensors to create a comprehensive understanding of the system's environment and the aircraft's position.

In some aspects, the autonomous aircraft capturing and lifting system may include a visual line guidance and object recognition system. The system may be camera-based and may be configured to detect various visual cues, including line markings, objects, or symbols on the ground or in the surrounding environment, as well as human gestures from ground personnel.

In some implementations, the system may include an artificial intelligence/machine learning (AI/ML) component. This component may be trained on real-world airport operations data, allowing it to interface effectively with the sensor fusion system. The AI/ML component may assist in object, symbol, and gesture recognition, potentially improving the system's ability to interpret its environment.

Additionally, the AI/ML component may contribute to decision-making processes, potentially enhancing the system's autonomy and adaptability.

The AI/ML component may also provide additional safety features. For example, it may be capable of identifying potential hazards or unusual situations that might not be easily detected by traditional sensor systems. This enhanced situational awareness may contribute to safer operations in busy airport environments.

In some aspects, the system may include an interface component configured to access a digital twin of the operating environment. This digital twin may be a fixed representation of the airport or aircraft carrier layout stored in onboard memory, or it may be updated in real-time through wireless communications to reflect current conditions. By interfacing with this digital twin, the system may gain access to detailed information about the operating environment, potentially enhancing its ability to navigate and make decisions.

The digital twin interface may assist in the autonomous decision-making process by providing additional context for the system's operations. For example, it may offer information about scheduled aircraft movements, temporary obstacles, or changes in airport layout. This information may allow the system to anticipate challenges and adjust its operations accordingly, potentially improving efficiency and safety.

In some implementations, the digital twin data may reside in cloud-based storage systems, allowing for centralized management and real-time updates across multiple tow vehicles and airport systems. This cloud-based approach may offer several advantages for the autonomous aircraft capturing and lifting system.

The cloud infrastructure may provide scalable storage capacity, enabling the system to maintain detailed digital representations of multiple airports or aircraft carriers. This may allow tow vehicles to access up-to-date information about various operating environments, even when moving between different locations.

Real-time updates to the digital twin data may be facilitated through the cloud. As changes occur in the physical environment, such as temporary runway closures, construction zones, or equipment relocations, these updates may be immediately reflected in the cloud-based digital twin. Tow vehicles may then access this updated information in real-time, ensuring their operations are based on the most current environmental data.

The cloud-based digital twin may also enable collaborative updating and maintenance of the environmental data. Multiple stakeholders, including airport authorities, airlines, and ground handling companies, may contribute to and benefit from the shared digital representation. This collaborative approach may result in a more comprehensive and accurate digital twin.

In some aspects, the cloud-based digital twin may integrate data from various sources, including IoT sensors deployed throughout the airport, weather stations, and air traffic management systems. This integration may provide a rich, multi-layered representation of the operating environment, potentially enhancing the tow vehicle's ability to make informed decisions.

The cloud infrastructure may also facilitate advanced analytics and machine learning processes on the digital twin data. These processes may identify patterns, predict potential issues, and optimize routes based on historical and real-time data, potentially improving the efficiency and safety of tow vehicle operations.

The integration of these advanced control and sensing capabilities may result in a highly sophisticated autonomous aircraft capturing and lifting system. By combining sensor fusion, visual recognition, AI/ML capabilities, and digital twin integration, the system may be capable of performing complex aircraft handling and towing operations with a high degree of precision and adaptability.

In other aspects of the disclosure, the tow vehicle may be designed to operate in a wide range of environmental conditions, enhancing its versatility and reliability in various airport settings. In some aspects, the tow vehicle may be capable of functioning in temperatures ranging from −18° F. to +122° F., allowing for operation in both extremely cold and hot climates. The vehicle may also be designed to withstand up to 90% relative humidity, potentially enabling its use in humid coastal or tropical environments.

The drivetrain of the tow vehicle may incorporate advanced features for improved performance and reliability. In some implementations, the vehicle may be equipped with two individual drive units, each containing a redundant drive system (i.e., four total drive wheels). These drive systems may utilize twin electrical high-torque rotary drive hub gear motors, potentially providing enhanced traction and maneuverability. The power supply for these motors may be a 48V system, with a total effective power output of 20 kW AC. This configuration may offer a balance of power and efficiency suitable for aircraft towing operations.

In some implementations, for enhanced redundancy and performance, each drive wheel of the tow vehicle may be powered by its own dedicated motor, such as a 5 kW motor. This configuration may provide several potential benefits, including improved traction control, increased maneuverability, and enhanced fault tolerance.

The system may be designed to optimize efficiency during operation. For instance, once the initial inertia of the aircraft is overcome and the tow vehicle is in motion, the controller may selectively deactivate one or more motors. This approach may help conserve energy and extend the operational range of the vehicle.

The controller may continuously monitor various parameters such as wheel speed, traction, and power consumption. In some cases, if a wheel loses traction or if additional power is required, the system may rapidly reactivate the previously deactivated motors. This dynamic power management strategy may allow the tow vehicle to maintain optimal performance while minimizing energy consumption.

To enhance durability and reduce maintenance requirements, the tow vehicle may be fitted with solid rubber tires. These tires may offer increased resistance to wear and tear compared to pneumatic tires, potentially extending their operational lifespan and reducing the frequency of tire replacements.

The towing capacity of the vehicle may be substantial, potentially allowing it to handle a wide range of aircraft sizes. In some aspects, the tow vehicle may be capable of towing airframes with a maximum takeoff weight (MTOW) of up to 132,000 lbs. This capacity may enable the vehicle to service a variety of commercial and military aircraft, enhancing its versatility in different airport environments.

One of the key advantages of the tow vehicle may be its potential to improve space utilization in hangar and apron areas. The design and maneuverability of the vehicle may allow for more efficient positioning and movement of aircraft in confined spaces. In some cases, the use of this tow vehicle may increase the utilization of hangar space by up to 60% compared to conventional tow tractors. This improved space efficiency may lead to significant operational benefits for airports and maintenance facilities, potentially allowing for the accommodation of more aircraft in a given area or reducing the need for expansive hangar facilities.

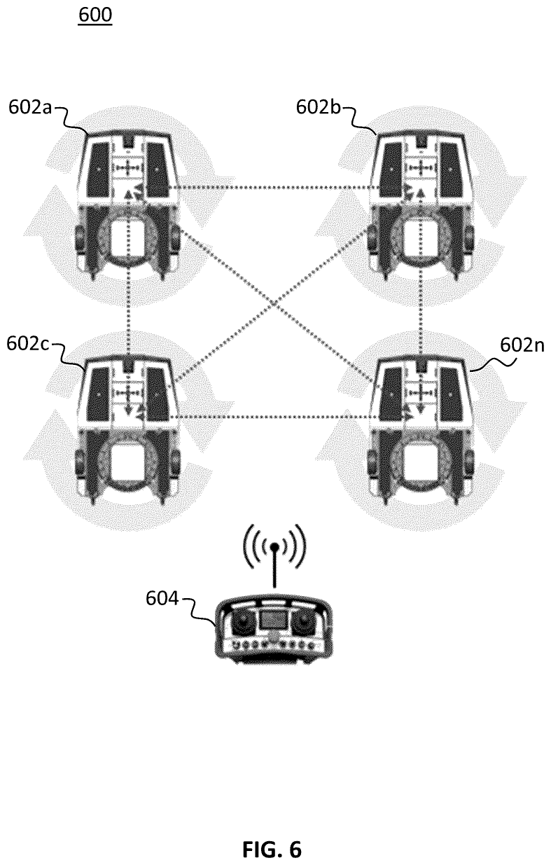

In some aspects, a multi-vehicle omnidirectional aircraft maneuvering system 600 may be utilized for efficient and precise aircraft handling operations. Referring to FIG. 6, the multi-vehicle omnidirectional aircraft maneuvering system 600 may comprise multiple tow vehicles arranged in a coordinated fashion and designed to work together to lift, maneuver, and deposit an aircraft in a new location. The system 600 may include two or more tow vehicles, illustrated as an example by a first tow vehicle 602a, a second tow vehicle 602b, a third tow vehicle 602c, and an nth tow vehicle 602n, arranged in a formation to collectively maneuver an aircraft.

The multi-vehicle omnidirectional aircraft maneuvering system 600 may also include a control unit 604 to communicate with and control the tow vehicles. The control unit 604 may be configured to control all tow vehicles simultaneously and synchronously, coordinating their movements for precise aircraft positioning.

In some cases, the tow vehicles in the multi-vehicle omnidirectional aircraft maneuvering system 600 may be capable of operating in various modes. The tow vehicles may operate semi-autonomously, with feedback from a human operator. This mode may allow for human oversight while leveraging the precision and coordination capabilities of the system.

The tow vehicles may also be configured to operate fully autonomously. In this mode, the tow vehicles may perform complex aircraft handling tasks without direct human control, utilizing their integrated sensor systems and the coordinated control provided by the control unit 604.

The tow vehicles in the multi-vehicle omnidirectional aircraft maneuvering system 600 may be networked with each other, allowing for seamless communication and coordination. This networking may enable the tow vehicles to work in unison, thereby improving the efficiency and precision of aircraft maneuvering operations.

In some implementations, the tow vehicles may be integrated with the sensor systems described earlier in the disclosure. These sensor systems may include sensors 104 and sensors 106, which may provide environmental awareness and aid in navigation. The integration of these sensor systems with the networked tow vehicles may enhance the overall capabilities of the multi-vehicle omnidirectional aircraft maneuvering system 600.

Each tow vehicle in the system may incorporate features such as caster wheels 108 and drive wheels 110, providing enhanced maneuverability. The tow vehicles may also include components such as the automated turntable 202, gate 204, and moving floor 210, which may contribute to their ability to capture and secure aircraft landing gear.

In some aspects, the multi-vehicle omnidirectional aircraft maneuvering system 600 may be particularly useful in complex airport environments, in confined spaces, and complex environments during aircraft maintenance, repair, and overhaul operations, e.g., in paint bays, docks for laser shock peening of aircraft surfaces, and other maintenance facilities, and in manufacturing, production, and final assembly environments of aircraft and aircraft subsystems. The system may navigate aircraft along pushback lines 508, taxiways 510, and centerlines 512, potentially improving the efficiency of ground operations in airport environments. In manufacturing and maintenance environments, the system may navigate aircraft along factory or maintenance floors using various visual guidance systems. The sensor systems integrated into each tow vehicle may be specifically adapted to detect and interpret floor markings, painted lines, embedded strips, or other visual indicia commonly found in industrial environments. The coordinated movement of multiple tow vehicles may allow for precise positioning of aircraft relative to passenger gates 506 and other airport structures and facilities.

The control unit 604 may utilize data from various sensors and components, such as the absolute encoder 216 and NLG clamps 212, to ensure accurate positioning and secure attachment to aircraft. This integration of sensor data with multi-vehicle coordination may enable the system to handle a wide range of aircraft types and sizes with enhanced precision and efficiency.

In some implementations, each of the first tow vehicle 602a, second tow vehicle 602b, third tow vehicle 602c, and nth tow vehicle 602n are equipped with a turntable lifting unit (TLU) as described earlier in the disclosure. In some cases, each tow vehicle in the system 600 may be capable of rotating 360 degrees in place, allowing for omnidirectional movement. This rotational capability may be achieved through the use of the automated turntable integrated into each vehicle's TLU. The automated turntable may allow each tow vehicle to adjust its orientation independently, potentially enabling precise positioning relative to the aircraft and other tow vehicles in the system.

The tow vehicles in the system 600 may be designed to move in any direction, facilitated by the combination of caster wheels and drive wheels. The caster wheels may provide enhanced maneuverability, allowing the vehicles to change direction quickly and smoothly. The drive wheels may provide the primary propulsion and may be independently controlled to enable complex movements and precise positioning.

In some implementations, each tow vehicle in the system 600 may be capable of capturing and lifting a portion of the aircraft's landing gear. For example, one tow vehicle may secure the nose landing gear using its TLU, while others may engage with the main landing gear. Each tow vehicle may perform the automated aircraft capturing process 300 described in FIG. 3, including lowering the TLU, unlocking and opening the gate, surrounding the respective landing gear, closing and locking the gate, adjusting the moving floor, lifting the landing gear, and clamping the landing gear.

In some aspects, the coordination of multiple tow vehicles in the system 600 may involve both asynchronous and synchronous execution of the automated aircraft capturing process 300. Certain steps in the process 300 may be performed by the different tow vehicles asynchronously, allowing each vehicle to operate at its own pace based on local conditions and positioning requirements. For example, the steps of unlocking and opening the gate 304 and 306, surrounding the respective landing gear 308, and closing and locking the gate 310 and 312 may be executed independently by each tow vehicle as they encounter and engage with their designated landing gear components.

This asynchronous approach may allow each tow vehicle to adapt to variations in positioning, timing, or local environmental factors without requiring the entire system to wait for the slowest vehicle to complete each step. The flexibility of asynchronous operation may enhance the efficiency of the overall capturing process, particularly when dealing with aircraft that may have different landing gear configurations, with aircraft configurations where the landing gear may be up in a retracted position down on the floor in an extended position, or even aircraft with broken landing gear configurations, or when operating in environments with varying surface conditions.

However, other steps in the process 300 may require synchronous execution to maintain aircraft stability and safety. The lifting of the landing gear 316 may be performed in unison by all engaged tow vehicles to avoid creating an imbalance in the aircraft. Coordinated lifting may help ensure that the aircraft's weight is distributed evenly across all lifting points, potentially preventing structural stress or instability that could result from uneven lifting forces.

The control unit 604 may monitor the progress of each tow vehicle through the asynchronous phases of the process 300 and coordinate the transition to synchronous operation when needed. This coordination may involve waiting for all tow vehicles to complete their individual capturing sequences before initiating the synchronized lifting phase, ensuring that all landing gear components are properly secured before any lifting forces are applied.

Once all tow vehicles have successfully captured their respective landing gear portions, the multi-vehicle system 600 may collectively perform the automated pushback process 400 illustrated in FIG. 4, including initiating pushback, aligning with pushback lines, automatically adjusting during pushback operations, detecting intersections, determining turn directions, rotating the aircraft, and lowering and releasing the aircraft. The coordinated operation may enable the system 600 to navigate complex airport environments as shown in FIG. 5, following pushback lines 508, taxiways 510, and centerlines 512 while maintaining precise control over the aircraft's position and orientation throughout the entire maneuvering operation.

Returning to the control unit 604, it may communicate with each tow vehicle, synchronizing their movements to ensure that the aircraft is lifted, moved, and deposited in a coordinated manner. This synchronization may involve precise control of each vehicle's automated turntable, gate, and moving floor components. In some cases, the sensors integrated into each tow vehicle may provide real-time feedback to the control unit 604. This feedback may include information about the position and orientation of each vehicle relative to the aircraft and to each other. The control unit 604 may use this data to make continuous adjustments to the position and movement of each tow vehicle, potentially ensuring smooth and precise aircraft maneuvering.

The absolute encoder in each tow vehicle's TLU may provide accurate rotational position data to the control unit 604. This data may be used to coordinate the rotational movements of all tow vehicles in the system 600, potentially allowing for complex maneuvers such as rotating the entire aircraft in place or moving it sideways.

In some implementations, the multi-vehicle omnidirectional aircraft maneuvering system 600 may be capable of moving aircraft in confined spaces where traditional towing methods may be impractical. For example, the system 600 may be used to precisely position aircraft relative to passenger gates, or to navigate along pushback lines, taxiways, and centerlines in tight airport environments. Further examples for movement and precise positioning of aircraft in confined spaces pertain to complex environments during aircraft maintenance, repair, and overhaul operations, e.g., in paint bays, docks for laser shock peening of aircraft surfaces, and other maintenance facilities, and in manufacturing, production, and final assembly environments of aircraft and aircraft subsystems.

The coordinated operation of multiple tow vehicles in the system 600 may allow for the distribution of the aircraft's weight across several points. This distribution may potentially reduce the stress on any single point of the aircraft's structure during lifting, maneuvering, and lowering operations. In some cases, this approach may allow the system 600 to handle a wider range of aircraft sizes and weights compared to single-vehicle towing systems.

The multi-vehicle omnidirectional aircraft maneuvering system 600 may include a control unit 604 that plays a central role in coordinating and managing the operations of the multiple tow vehicles. The control unit 604 may be equipped with wireless communication capabilities, allowing it to establish and maintain connections with the first tow vehicle 602a, second tow vehicle 602b, third tow vehicle 602c, and nth tow vehicle 602n. The control unit 604 may also be configured with a wired or tethered connection to one or more of the tow vehicles to provide a cyber-attack resilient solution that may not be compromised remotely and which may be specifically suited for operations in restricted, denied, contested, or highly secure environments.

In some cases, the control unit 604 may utilize a mesh network topology to facilitate communication between the tow vehicles. This mesh network configuration may allow each tow vehicle to act as a node, relaying information to other vehicles in the system. The mesh network topology may provide several advantages for the multi-vehicle omnidirectional aircraft maneuvering system 600, such as increased reliability and redundancy in communication pathways.

The control unit 604 may coordinate the movements of the tow vehicles by sending synchronized commands to each vehicle. These commands may include instructions for speed, direction, and positioning relative to the aircraft and other tow vehicles. The control unit 604 may process data from various sources, including the sensor systems integrated into each tow vehicle, to make real-time decisions and adjustments to the vehicles'movements.

In some implementations, the control unit 604 may integrate with one or more sensor fusion systems. These sensor fusion systems may combine data from multiple sensors, such as the sensors 104 and sensors 106 described earlier, to create a comprehensive understanding of the operational environment. The sensor fusion systems may provide the control unit 604 with detailed information about the positions of the tow vehicles, the aircraft, and any potential obstacles in the vicinity.

The control unit 604 may also utilize one or more assisting camera systems to enhance its situational awareness and decision-making capabilities. These camera systems may provide visual data that complements the information gathered by other sensors, potentially allowing for more accurate positioning and obstacle detection.

By integrating data from the sensor fusion systems and assisting camera systems, the control unit 604 may enable enhanced safety and coordination among the tow vehicles. For example, the control unit 604 may use this comprehensive sensor data to detect potential collisions between tow vehicles or between a tow vehicle and an obstacle. In response to such detection, the control unit 604 may issue commands to adjust the movements of the tow vehicles to avoid collisions while maintaining the overall coordination of the aircraft maneuvering operation.

The control unit 604 may also use the sensor data to optimize the positioning and movements of the tow vehicles relative to the aircraft. The sensor data may include various types of information, such as proximity measurements, orientation data, and position data including GPS location information. This GPS location information may provide precise geographical coordinates for each tow vehicle and the aircraft, enabling the control unit 604 to maintain accurate spatial awareness of the entire system within the airport environment. For instance, the control unit 604 may continuously monitor the distance and alignment between each tow vehicle and its corresponding aircraft landing gear, making adjustments as necessary to maintain proper engagement throughout the maneuvering process. The integration of GPS data may also allow the control unit 604 to coordinate movements with airport traffic management systems and ensure compliance with designated aircraft movement zones and pathways.

In some cases, the control unit 604 may be programmed with predefined maneuvering patterns or algorithms. These patterns may be designed to efficiently move aircraft in various scenarios, such as pushing back from a passenger gate, navigating along a pushback line, positioning an aircraft on a taxiway, or precision positioning of aircraft in confined spaces and complex environments during aircraft maintenance, repair, and overhaul operations, e.g., in paint bays, docks for laser shock peening of aircraft surfaces, and other maintenance facilities, and in manufacturing, production and final assembly environments of aircraft and aircraft subsystems. The control unit 604 may adapt these predefined patterns based on real-time sensor data, potentially allowing for flexible and efficient aircraft movements in dynamic airport environments.

The wireless communication capabilities of the control unit 604 may allow for remote monitoring and control of the multi-vehicle omnidirectional aircraft maneuvering system 600. In some implementations, the control unit 604 may be connected to a centralized airport management system, enabling coordination with other ground operations and air traffic control. The control unit 604 may also be configured with a wired or tethered connection to provide a cyber-attack resilient solution that may not be compromised remotely and which may be specifically suited for operations in restricted, denied, contested, or highly secure environments, or in environments where recording, transmission, and storage of data is prohibited at all times.

In some aspects, the control unit 604 may be embodied in various forms, including software, hardware, firmware, or any combination thereof. The control unit 604 may be implemented as a dedicated hardware device with embedded software applications, or it may comprise a general-purpose computing platform running specialized control software. In some implementations, the control unit 604 may utilize firmware to provide low-level control functions while higher-level coordination algorithms may be implemented in software applications.

The control unit 604 may comprise a portable apparatus, such as a handheld device, designed for use by ground personnel. This portable configuration may include a ruggedized tablet or specialized control console with one or more software applications embedded therein. The portable control unit 604 may feature a touchscreen interface, physical control buttons, and wireless communication capabilities to enable real-time interaction with the tow vehicles. In some cases, the portable control unit 604 may include GPS functionality, allowing operators to track their position relative to the aircraft and tow vehicles during maneuvering operations.

In some implementations, the control unit 604 may interface with one or more cloud services to provide enhanced control functionality. These cloud services may offer additional computational resources, data storage capabilities, and advanced analytics that may not be available on a local device.

The cloud interface may enable the control unit 604 to access real-time weather data, airport traffic information, and updated aircraft specifications that may influence maneuvering operations. Additionally, cloud services may provide machine learning capabilities that may continuously improve the system's performance based on operational data collected from multiple airports and aircraft types.

In other embodiments, the control unit 604 may be implemented on board at least one of the tow vehicles and operate in a master-slave paradigm. In this configuration, one tow vehicle may serve as the master unit, housing the primary control unit 604, while the remaining tow vehicles may function as slave units that receive and execute commands from the master. The master tow vehicle may coordinate all aspects of the multi-vehicle operation, including synchronization of movements, distribution of tasks, and monitoring of system status. The slave tow vehicles may maintain their own local control systems for basic operations while deferring to the master unit for coordination and high-level decision making.

The master-slave configuration may provide several advantages, including reduced communication latency between the control unit 604 and at least one tow vehicle, enhanced system reliability through distributed processing, and simplified deployment since no separate control device may be required. In some cases, the master role may be dynamically assigned based on factors such as vehicle position, system health, or operational requirements, allowing for flexible adaptation to changing conditions.

In still other embodiments, the control unit 604 may be implemented in a server or cloud architecture with wireless communications being transmitted via any suitable means. This server-based implementation may utilize wide area networks, including cellular networks, Wi-Fi infrastructure, or dedicated airport communication systems, to maintain connectivity with the tow vehicles. In some cases, satellite communication may be employed to provide coverage in remote locations or to ensure continuous connectivity regardless of terrestrial network availability.

The server-based control unit 604 may offer enhanced computational capabilities, allowing for complex optimization algorithms, real-time data processing from multiple sources, and integration with broader airport management systems. This architecture may enable centralized control of multiple multi-vehicle systems operating simultaneously across different areas of an airport or across multiple airports within a network. The server implementation may also facilitate remote monitoring and support, allowing technical personnel to oversee operations and provide assistance from off-site locations.

In some implementations, the control unit 604 may employ a hybrid architecture that combines multiple embodiments. For example, a portable handheld device may serve as the primary interface for ground personnel while communicating with a cloud-based processing system that handles complex coordination algorithms. Alternatively, an on-board master control unit may interface with cloud services for enhanced functionality while maintaining local control capabilities for critical operations.

The control unit 604 may include a user interface that provides operators with various methods for interacting with and controlling the multi-vehicle omnidirectional aircraft maneuvering system 600. This user interface may comprise physical controls, software controls, or a combination of both, depending on the specific implementation and operational requirements.

Physical controls may include joysticks for directional movement commands, allowing operators to intuitively guide the coordinated movement of the tow vehicles. Push buttons may be incorporated for specific functions such as emergency stops, system activation, or mode selection. Toggle switches may provide operators with the ability to switch between different operational modes or enable specific system features. Rotary knobs may allow for fine adjustment of parameters such as movement speed or positioning precision. In some cases, the physical controls may include tactile feedback mechanisms, such as force feedback joysticks or vibrating buttons, to provide operators with sensory confirmation of their inputs.

Software controls may be implemented through one or more graphical user interfaces displayed on touchscreen devices, computer monitors, or specialized display panels. These graphical interfaces may present operators with virtual buttons, sliders, and control panels that can be manipulated through touch input or cursor-based interaction. The software controls may include visual representations of the tow vehicles and aircraft, allowing operators to monitor system status and positioning in real-time. Interactive maps or diagrams of the airport environment may be displayed, enabling operators to plan and visualize movement paths. In some implementations, the software controls may incorporate augmented reality features, overlaying control elements onto live camera feeds or three-dimensional representations of the operational environment.

The user interface may combine physical and software controls to leverage the advantages of both approaches. For example, physical joysticks may be used for primary movement control while software interfaces provide detailed system monitoring and configuration options. Emergency stop buttons may be implemented as physical controls for immediate accessibility, while routine operational parameters may be adjusted through software interfaces.

In some aspects, control functionality may be distributed across two or more devices based on different operator roles and responsibilities. A primary operator may use a master control device with comprehensive control capabilities, including movement commands, system configuration, and emergency controls. A secondary operator may utilize a monitoring device that provides system status information and limited control functions, such as the ability to halt operations or adjust specific parameters. Supervisory personnel may access a management interface that provides oversight capabilities, operational reporting, and system configuration options without direct control over vehicle movements.

In some implementations, the user interface may support multiple simultaneous operators, allowing for collaborative control of complex maneuvering operations. Communication features may be integrated into the interface, enabling operators to coordinate their actions and share information during multi-person operations. The system may include operator identification and authentication features to ensure that only authorized personnel can access specific control functions.

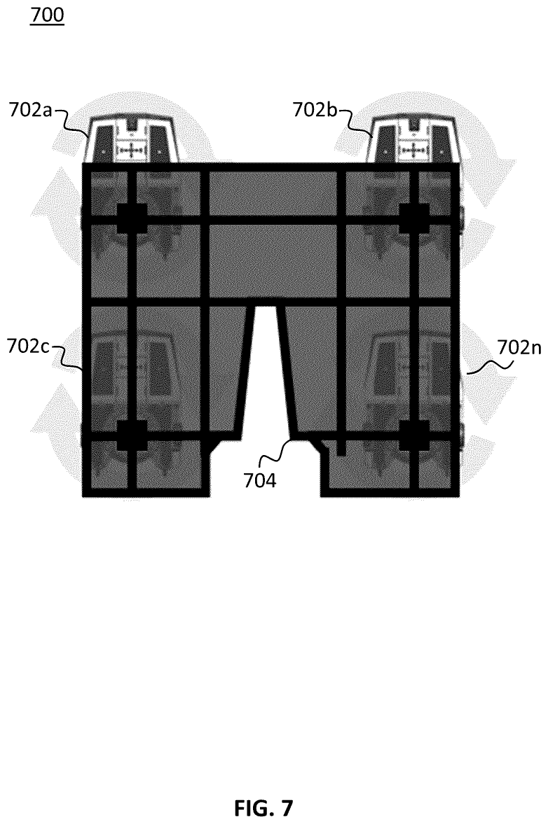

In some aspects, a multi-vehicle omnidirectional aircraft maneuvering system 700 may be utilized for efficient and precise handling of large objects, such as aircraft. Referring to FIG. 7, the multi-vehicle omnidirectional aircraft maneuvering system 700 may comprise multiple tow vehicles arranged in a coordinated fashion. The system 700 may include two or more tow vehicles, illustrated as an example by a first tow vehicle 702a, a second tow vehicle 702b, a third tow vehicle 702c, and an nth tow vehicle 702n, arranged in a formation to collectively maneuver an object.

The multi-vehicle omnidirectional aircraft maneuvering system 700 may also include a support platform 704. The support platform 704 may be designed to interface with all four tow vehicles simultaneously, creating a unified lifting and transport system. In some cases, the tow vehicles may be configured to engage with the single support platform 704 placed beneath the aircraft.

The support platform 704 may be a rectangular structure with a central opening, designed to accommodate various aircraft configurations. The central opening may allow the support platform 704 to be positioned around the landing gear of an aircraft without interfering with other aircraft components. In some implementations, the support platform 704 may have different shapes based on the number of tow vehicles and the specific configuration requirements of the aircraft being maneuvered. For example, a triangular support platform may be utilized when the system employs three tow vehicles, providing optimal weight distribution and stability for smaller aircraft or specific maneuvering scenarios. Similarly, a hexagonal support platform may be employed with six tow vehicles for handling larger aircraft or when enhanced stability and load distribution are required. The shape and size of the support platform 704 may be selected to match the aircraft's dimensions, weight distribution characteristics, and the operational requirements of the specific maneuvering task, potentially allowing for customized configurations that optimize both safety and efficiency during aircraft handling operations.

In some implementations, the support platform 704 may be constructed as a completely rigid structure, providing a solid and stable foundation for aircraft handling operations. This rigid configuration may offer maximum structural integrity and precise positioning capabilities during maneuvering operations.

Alternatively, the support platform 704 may incorporate a combination of rigid and flexible components to enhance its adaptability and aircraft compatibility. In some aspects, the support platform 704 may include a cradle configured to provide uniform support to the underbody of the aircraft. This cradle may comprise straps, netting, webbing, or similar flexible materials that are held taut by the rigid framework of the support platform 704. The flexible cradle components may conform to the contours of different aircraft underbodies, potentially distributing the aircraft's weight more evenly and reducing pressure points that could cause structural stress or damage.

In other implementations, the support platform 704 may be topped with a flexible layer to provide additional cushioning and adaptability. This flexible layer may take the form of an air cushion system that can be inflated or deflated as needed to accommodate different aircraft configurations and weight distributions. The air cushion may be adjustable in real-time, allowing the system to optimize support characteristics during different phases of the maneuvering operation. For instance, the air cushion may be inflated to a higher pressure during lifting operations to provide firm support, and then adjusted to a lower pressure during transport to provide more gentle cushioning. For example, the flexible layer may be specifically suited for rescue operations of aircraft, e.g., when the landing gear configuration of an aircraft is partially or entirely damaged or broken off.

The combination of rigid structural elements with flexible support components may allow the support platform 704 to maintain precise positioning control while simultaneously providing adaptive support that can accommodate variations in aircraft design, weight distribution, and operational requirements. This hybrid approach may enhance both the safety and versatility of the multi-vehicle omnidirectional aircraft maneuvering system 700.

In some implementations, each tow vehicle in the system 700 may be equipped with components similar to those described earlier, such as an automated turntable, a gate, and a moving floor. These components may allow each tow vehicle to interface securely with the support platform 704.

The tow vehicles in the system 700 may be designed to move in any direction, facilitated by the combination of caster wheels and drive wheels. This omnidirectional capability may allow for precise positioning of the support platform 704 beneath the aircraft.

In some cases, the multi-vehicle omnidirectional aircraft maneuvering system 700 may be configured with two or more groups of two or more tow vehicles. Each group may engage with a separate platform or cradle to support different parts of the aircraft. For example, one group of tow vehicles may support the front section of the aircraft using one platform, while another group supports the rear section using a separate platform.

The coordinated operation of the tow vehicles in the system 700 may be managed by a control unit. The control unit may communicate with each tow vehicle, synchronizing their movements to ensure that the support platform 704 is positioned, lifted, moved, and lowered in a coordinated manner. This synchronization may involve precise control of each vehicle's automated turntable, gate, and moving floor components.

In some implementations, sensors integrated into each tow vehicle may provide real-time feedback to the control unit. This feedback may include information about the position and orientation of each vehicle relative to the support platform 704 and to each other. The control unit may use this data to make continuous adjustments to the position and movement of each tow vehicle, potentially ensuring smooth and precise maneuvering of the supported aircraft.

The absolute encoder in each tow vehicle's automated turntable may provide accurate rotational position data to the control unit. This data may be used to coordinate the rotational movements of all tow vehicles in the system 700, potentially allowing for complex maneuvers such as rotating the entire aircraft in place or moving it sideways while supported on the platform 704.

In some cases, the multi-vehicle omnidirectional aircraft maneuvering system 700 may be capable of moving aircraft in confined spaces where traditional towing methods may be impractical. For example, the system 700 may be used to precisely position aircraft relative to passenger gates, or to navigate along pushback lines, taxiways, and centerlines in tight airport environments. Further examples for usage of system 700 are movements and precision positioning of aircraft in confined spaces and complex environments during aircraft maintenance, repair, and overhaul operations, e.g., in paint bays, docks for laser shock peening of aircraft surfaces, and other maintenance facilities, and in manufacturing, production, and final assembly environments of aircraft and aircraft subsystems.

The coordinated operation of multiple tow vehicles in the system 700, combined with the support platform 704, may allow for the distribution of the aircraft's weight across several points. This distribution may potentially reduce the stress on any single point of the aircraft's structure during lifting and maneuvering operations. In some cases, this approach may allow the system 700 to handle a wider range of aircraft sizes and weights compared to single-vehicle towing systems.

The omnidirectional movement capability of the system 700 may provide advantages in maneuvering large objects like aircraft. The ability to move in any direction without the need for wide turning radii may allow for more efficient use of space in crowded areas. Additionally, the precise control afforded by the coordinated operation of multiple tow vehicles may enable accurate positioning of aircraft for maintenance, storage, or preparation for flight.

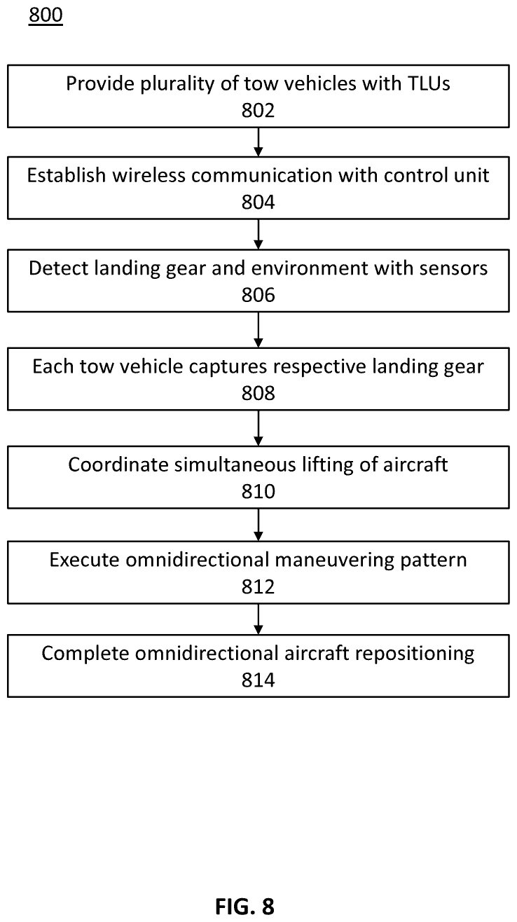

Referring to FIG. 8, a method 800 for omnidirectional aircraft maneuvering using multiple vehicles is illustrated as a flowchart. The method 800 may provide a systematic approach for coordinating multiple tow vehicles to achieve precise aircraft positioning and movement capabilities.

The method 800 begins at step 802, where a plurality of tow vehicles are provided, each tow vehicle comprising a turntable lifting unit (TLU) configured to capture and secure a portion of an aircraft's landing gear. In some aspects, each TLU may comprise an automated turntable, a gate configured to open and close to receive landing gear, and a moving floor configured to support the landing gear. The plurality of tow vehicles may comprise at least three tow vehicles, with each tow vehicle potentially being assigned to a respective landing gear of the aircraft. Each tow vehicle may be capable of rotating 360 degrees while maintaining engagement with the respective landing gear, providing enhanced maneuverability during aircraft handling operations. In alternative embodiments where one or more of the aircraft's landing gear are damaged or completely broken off, one or more of the tow vehicles may be outfitted with a specialized attachment mechanism such as a sling, harness, cradle, clamp, or other custom fixture designed to capture and/or support the broken landing gear or engage with a different structural component of the aircraft altogether. These specialized attachment mechanisms may be interchangeable with standard TLUs and configured to distribute weight appropriately while maintaining the system's omnidirectional maneuvering capabilities. For aircraft with severely compromised landing gear systems, multiple tow vehicles may be equipped with these specialized attachments to engage with alternative structural hard points on the aircraft's fuselage or wings, enabling safe transport and positioning even in emergency recovery scenarios.

The method 800 proceeds to step 804, where wireless communication is established with each of the plurality of tow vehicles using a control unit. This communication establishment may enable the control unit to coordinate simultaneous movement of the plurality of tow vehicles to maneuver the aircraft omnidirectionally. The wireless communication may facilitate real-time data exchange between the control unit and each tow vehicle, allowing for synchronized operations and coordinated movements throughout the maneuvering process.

At step 806, the method 800 involves detecting the position and orientation of the aircraft's landing gear, location information of the tow vehicle, and information about the surrounding environment using a sensor system of each tow vehicle. The control unit may receive real-time sensor data from each tow vehicle's sensor system and process location information for spatial awareness within an airport environment. This sensor data may enable the control unit to coordinate movements of the plurality of tow vehicles with airport traffic management systems, potentially enhancing safety and operational efficiency.

The method 800 continues to step 808, where each tow vehicle captures its respective landing gear. This capturing process may involve the automated operation of each TLU, including the opening and closing of gates, adjustment of moving floors, and positioning of automated turntables to securely engage with the designated landing gear components. The capturing process may be performed asynchronously by different tow vehicles, allowing each vehicle to adapt to local conditions and positioning requirements.

In alternative embodiments where the aircraft's landing gear is damaged, partially broken, or completely severed, the capturing process at step 808 may be adapted to accommodate these compromised conditions. One or more tow vehicles may be equipped with specialized attachment mechanisms that can engage with broken landing gear components or alternative structural hard points on the aircraft. These specialized mechanisms may include adjustable slings that can wrap around damaged landing gear struts, providing support even when the wheel assemblies are missing or severely compromised.

At step 810, the method 800 involves coordinating simultaneous lifting of the aircraft by synchronizing the TLUs of the plurality of tow vehicles using the control unit. This coordination may include monitoring lifting forces applied by each tow vehicle to maintain balanced weight distribution across multiple contact points and adjusting lifting operations in real-time to prevent structural stress on the aircraft during the lifting process. The synchronized lifting may ensure that the aircraft's weight is distributed evenly across all lifting points, potentially preventing structural imbalance or instability.

The method 800 proceeds to step 812, where an omnidirectional maneuvering pattern is executed. This step may involve the control unit executing at least one aircraft maneuvering operation with input from real-time sensor data from the plurality of tow vehicles. The maneuvering operation may be implemented across a spectrum of autonomy levels, ranging from fully manual control to complete autonomous operation.

In fully manual mode, human operators may directly control each aspect of the maneuvering operation through the control unit, with the system providing real-time feedback and safety monitoring. The control unit may still manage basic synchronization between vehicles to prevent collisions or unsafe operations, but all directional commands and positioning decisions may be made by the operator.

In semi-autonomous mode, the system may operate with varying degrees of human oversight and intervention. At the lower end of semi-autonomous operation, the control unit may execute predefined maneuvers while requiring human confirmation before initiating each major movement phase, such as lifting, rotating, or repositioning operations. At intermediate levels, human operators may provide high-level directional commands or destination coordinates, while the control unit autonomously determines the optimal path and coordinates the detailed movements of individual tow vehicles. At higher levels of semi-autonomous operation, the system may operate independently for routine maneuvers while requesting human input only for complex decisions, obstacle avoidance scenarios, or when encountering unexpected conditions. Throughout all semi-autonomous modes, the control unit may continuously manage the synchronization and coordination among the plurality of vehicles to ensure safe and efficient operation.

In fully autonomous mode, the maneuvering operation may be executed entirely based on predefined directives, patterns, and real-time sensor data without requiring human intervention. The control unit may analyze the operational environment, determine optimal maneuvering strategies, and execute complex multi-vehicle coordination patterns while continuously monitoring for safety conditions and adapting to dynamic environmental changes. The system may utilize artificial intelligence and machine learning algorithms to optimize performance and adapt to varying aircraft types, environmental conditions, and operational requirements.

Regardless of the autonomy level selected, the control unit may maintain responsibility for managing the synchronization and coordination among the plurality of vehicles to ensure that all tow vehicles operate in harmony throughout the maneuvering process. The maneuvering operation may enable the coordinated movement of all tow vehicles to position the aircraft in any desired direction without the constraints of traditional towing methods. The omnidirectional capability may allow for precise positioning in confined spaces and complex airport environments.

The method 800 concludes at step 814, where omnidirectional aircraft repositioning is completed. This final step may involve the successful placement of the aircraft in its desired location and orientation, followed by the coordinated lowering and release of the aircraft's landing gear. The completion of repositioning may include verification that all tow vehicles have safely disengaged from the aircraft and that the aircraft is properly positioned for subsequent operations.

In some implementations, the method 800 may further comprise interfacing a support platform with the plurality of tow vehicles, where the support platform is positioned beneath the aircraft and provides distributed weight support across multiple contact points on the aircraft. This support platform configuration may enhance the stability and weight distribution capabilities of the multi-vehicle system during aircraft maneuvering operations.

The method 800 may provide advantages in aircraft handling efficiency, precision, and safety by leveraging the coordinated operation of multiple tow vehicles. The systematic approach outlined in the flowchart may enable complex aircraft maneuvering tasks to be performed with enhanced control and reduced risk compared to traditional single-vehicle towing methods.

In some aspects, the methods and systems presented herein may be embodied in hardware, software, firmware, or a combination thereof. The hardware components of the system may include one or more processors, memory devices, storage units, input/output interfaces, and network communication modules. The software and firmware may include non-transitory machine executable code stored on a computer-readable medium. The non-transitory machine executable code may include various modules corresponding to different system components. These modules may communicate through well-defined APIs, allowing for modular development and easier maintenance. The non-transitory machine executable code may be written in any suitable programming language and may be stored on various types of non-transitory computer-readable media, such as magnetic disks, optical disks, solid-state drives, or other storage devices. The code may be compiled, interpreted, or executed by one or more processors to implement the functionalities of the document review and approval system.

In some cases, the system may be implemented using a client-server architecture, where the user interface components run on client devices (e.g., the control unit) while the AI engine and other processing components operate on one or more servers. Alternatively, the entire system may be implemented as a standalone application running on a single device. In some implementations, the system may be deployed in a cloud computing environment, allowing for scalability and distributed processing. The various components of the system may be implemented as microservices, each running in its own container and communicating with other components through well-defined APIs.

The user interfaces may be implemented using various web technologies, such as HTML, CSS, and JavaScript, allowing for cross-platform compatibility and accessibility through web browsers. Native desktop and/or mobile applications may also be developed to provide access to the system on personal computers, smartphones, and tablets.

The AI/ML components may be implemented using machine learning frameworks and libraries, which may be regularly updated to incorporate the latest advancements in natural language processing and system automation techniques. The system may also include mechanisms for continuous learning and improvement based on user feedback, interaction data, and sensor data.

The use of the term “exemplary” in this disclosure may refer to “example” or “illustrative” and may not imply any preference or requirement. The use of the singular form of any word may include the plural and vice versa. Words importing a particular gender may include every other gender. The use of “or” may not be exclusive and may include “and/or” unless the context clearly dictates otherwise. The phrases “in one embodiment,” “in some embodiments,” “in various embodiments,” “in other embodiments,” and the like may all refer to one or more of the same or different embodiments. The term “based on” may mean “based at least in part on.” The term “may” may be used to describe optional features or functions. Any dimensions, measurements, or quantities given may be approximate and may vary within normal operational ranges. The use of relative terms such as “above,” “below,” “upper,” “lower,” “horizontal,” “vertical,” “top,” “bottom,” “side,” “left,” and “right” may be used to describe the relationship of one element to another and may not imply any particular orientation or direction unless specifically stated. The use of “including,” “comprising,” “having,” and variations thereof may mean “including, but not limited to” unless otherwise specified. Any sequence of steps or operations described may be varied or performed in a different order unless otherwise specified. Any numerical range recited may include all values from the lower value to the upper value and all possible sub-ranges in between.

The term “about” or “approximately” may mean within an acceptable error range for the particular value as determined by one of ordinary skill in the art, which may depend in part on how the value is measured or determined.

A number of implementations have been described. Nevertheless, it will be understood that various modifications may be made without departing from the spirit and scope of the disclosure. Accordingly, other implementations are within the scope of the following claims.

1. A multi-vehicle omnidirectional aircraft maneuvering system, comprising:
a plurality of tow vehicles, each tow vehicle comprising a turntable lifting unit (TLU) configured to capture and secure a portion of an aircraft's landing gear or other structural hard point of the aircraft;
a control unit configured to communicate with and coordinate the movements of the plurality of tow vehicles; and
wherein each TLU comprises an automated turntable, a gate configured to open and close to receive landing gear, and a moving floor configured to support the landing gear.

2. The system of claim 1, wherein each tow vehicle further comprises:
a sensor system configured to detect: the position and orientation of the aircraft's landing gear, location information of the tow vehicle, and information about the surrounding environment.

3. The system of claim 2, wherein the control unit is configured to:
receive real-time sensor data from each tow vehicle's sensor system;
process location information for spatial awareness within an airport environment; and
coordinate movements with airport traffic management systems.

4. The system of claim 1, wherein the control unit is configured to:
establish wireless communication with each of the plurality of tow vehicles; and
synchronize the operations of all TLUs; and
coordinate simultaneous movement of the plurality of tow vehicles to maneuver the aircraft omnidirectionally.

5. The system of claim 4, wherein the control unit is further configured to:
coordinate simultaneous lifting of the aircraft by synchronizing the TLUs of the plurality of tow vehicles.

6. The system of claim 5, wherein the control unit is further configured to:
monitor lifting forces applied by each tow vehicle to maintain balanced weight distribution across multiple contact points; and
adjust lifting operations in real-time to prevent structural stress on the aircraft during the lifting process.

7. The system of claim 1, wherein the plurality of tow vehicles comprises at least three tow vehicles, and wherein each tow vehicle is assigned to a landing gear of the aircraft.

8. The system of claim 7, wherein each of the plurality of tow vehicles is capable of rotating 360 degrees while maintaining engagement with the respective landing gear.

9. The system of claim 1, wherein the control unit is configured to autonomously execute at least one predefined aircraft maneuvering pattern based on real-time sensor data from the plurality of tow vehicles.

10. The system of claim 1, further comprising a support platform configured to interface with the plurality of tow vehicles, wherein the support platform is positioned beneath the aircraft and provides distributed weight support across multiple contact points on the aircraft.

11. A method for omnidirectional aircraft maneuvering using multiple vehicles, comprising:
providing a plurality of tow vehicles, each tow vehicle comprising a turntable lifting unit (TLU) configured to capture and secure a portion of an aircraft's landing gear;
communicating with and coordinating the movements of the plurality of tow vehicles using a control unit; and
synchronously operating all of the TLUs with the control unit, wherein each TLU comprises an automated turntable, a gate configured to open and close to receive landing gear, and a moving floor configured to support the landing gear.

12. The method of claim 11, further comprising:
detecting, using a sensor system of each tow vehicle: the position and orientation of the aircraft's landing gear, location information of the tow vehicle, and information about the surrounding environment.

13. The method of claim 12, further comprising:
receiving real-time sensor data from each tow vehicle's sensor system using the control unit;
processing, by the control unit, location information for spatial awareness within an airport environment; and
coordinating, by the control unit, movements of the plurality of tow vehicles with airport traffic management systems.

14. The method of claim 11, further comprising:
establishing wireless communication with each of the plurality of tow vehicles using the control unit;
synchronizing, by the control unit, the operations of all TLUs; and
coordinating, by the control unit, simultaneous movement of the plurality of tow vehicles to maneuver the aircraft omnidirectionally.

15. The method of claim 14, further comprising:
coordinating, by the control unit, simultaneous lifting of the aircraft by synchronizing the TLUs of the plurality of tow vehicles.

16. The method of claim 15, further comprising:
monitoring lifting forces applied by each tow vehicle to maintain balanced weight distribution across multiple contact points using the control unit; and
adjusting lifting operations in real-time to prevent structural stress on the aircraft during the lifting process.

17. The method of claim 11, wherein the plurality of tow vehicles comprises at least three tow vehicles, and further comprising:
assigning each tow vehicle to a respective landing gear of the aircraft.

18. The method of claim 17, further comprising:
rotating each of the plurality of tow vehicles 360 degrees while maintaining engagement with the respective landing gear.

19. The method of claim 11, further comprising:
autonomously executing at least one predefined aircraft maneuvering pattern based on real-time sensor data from the plurality of tow vehicles using the control unit.

20. The method of claim 11, further comprising:
interfacing a support platform with the plurality of tow vehicles, wherein the support platform is positioned beneath the aircraft and provides distributed weight support across multiple contact points on the aircraft.
